(19) United States
(12) Patent Application Publication
(10) Pub. No.: US 2022/0256786 A1
(43) Pub. Date: Aug. 18, 2022

(54) Internet Based Electronic Educational device for Landscape Irrigation

(71) Applicant: Frank Joseph Rauscher, Bonita, CA (US)

(72) Inventor: Frank Joseph Rauscher, Bonita, CA (US)

(21) Appl. No.: 17/177,456

(22) Filed: Feb. 17, 2021

(51) Int. Cl. A01G 25/02; A01B 79/00

(52) U.S. Cl. CPC A01G 25/02; A01B 79/005

(57) ABSTRACT

The invention is software comprised of algorithms and html web page design that provide users with actual on-sight analysis of soil composition, and proper irrigation instructions matching that soil type for various plant types and sizes. This educational online calculator provides methodology for acquiring soil composition type, and then requests a few simply inputs from the user. After initiating calculation, the calculator then reports two pages of irrigation (and planting) instructions as well as vital related information. The presence of this calculator on the cloud affords the user to inexpensively make use of the invention while actually present in the landscape where the plant is located. The educational aspects go further yet, as they include links to many gardening technical bulletins designed to help the user understand why they are being given the included recommendations and instructions.

NOTE: This Educational Device provides as part of the educational information many and various calculations upon the data that has been input by the “User” [*18]. There are five calculator sections within this device. The sections have been created for the benefit of the User in order to minimize confusion.

Within each Calculator Section there exists one or more “links” to an “Educational Support Document”. Each of these “Educational Bulletins” [*19] are designed to both educate the User regarding various horticultural issues and specifically to help the User correctly understand the question being asked within that particular calculator section.

These educational bulletins help to assure that the output recommendations are as accurate as possible. A PDF included with this submission titled “TB1113-TB1483.pdf” contains a copy of each such educational link. Many of these have previously been Copyrighted. The Document, titled “Copyright-GardenTips.pdf” is a copy of this registration and demonstrates the copyright for these Educational Documents, and is also included in this submission.

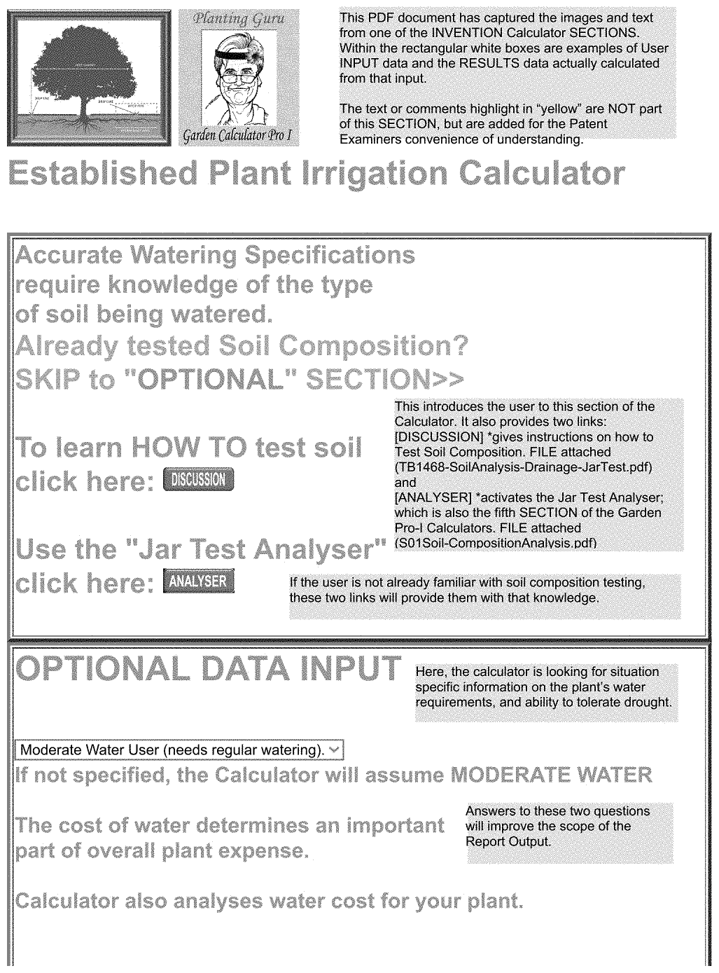

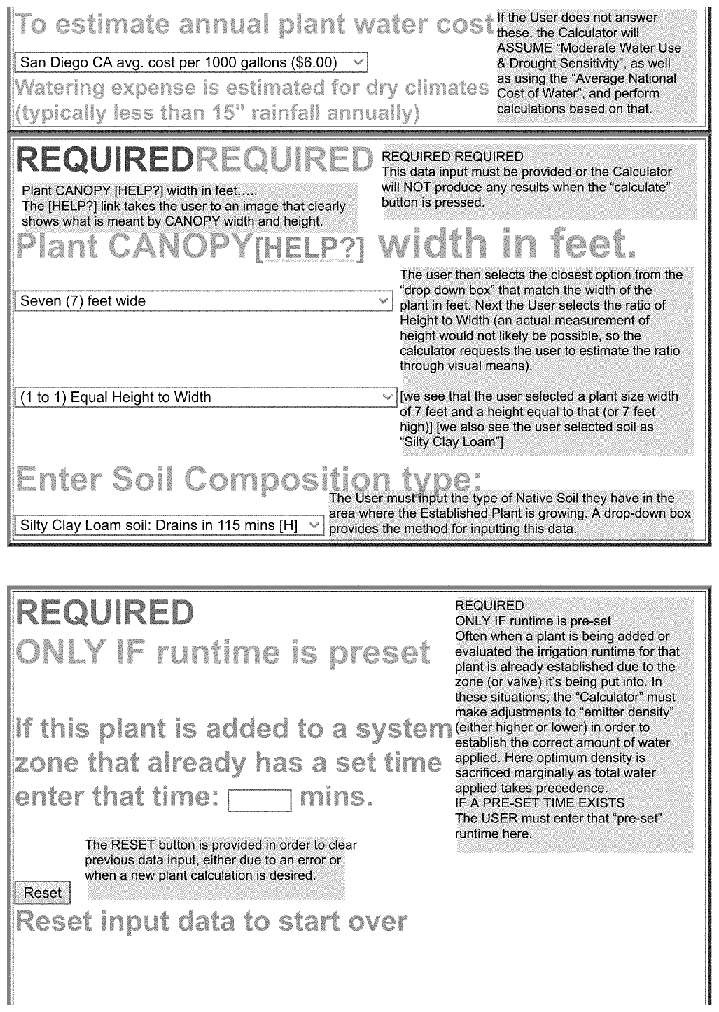

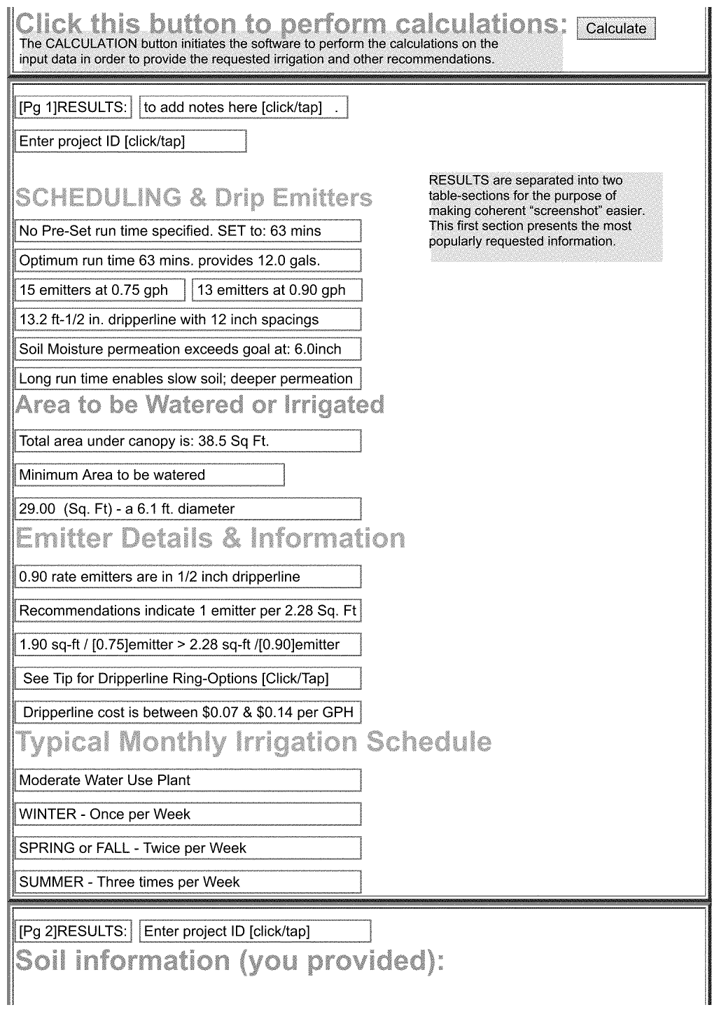

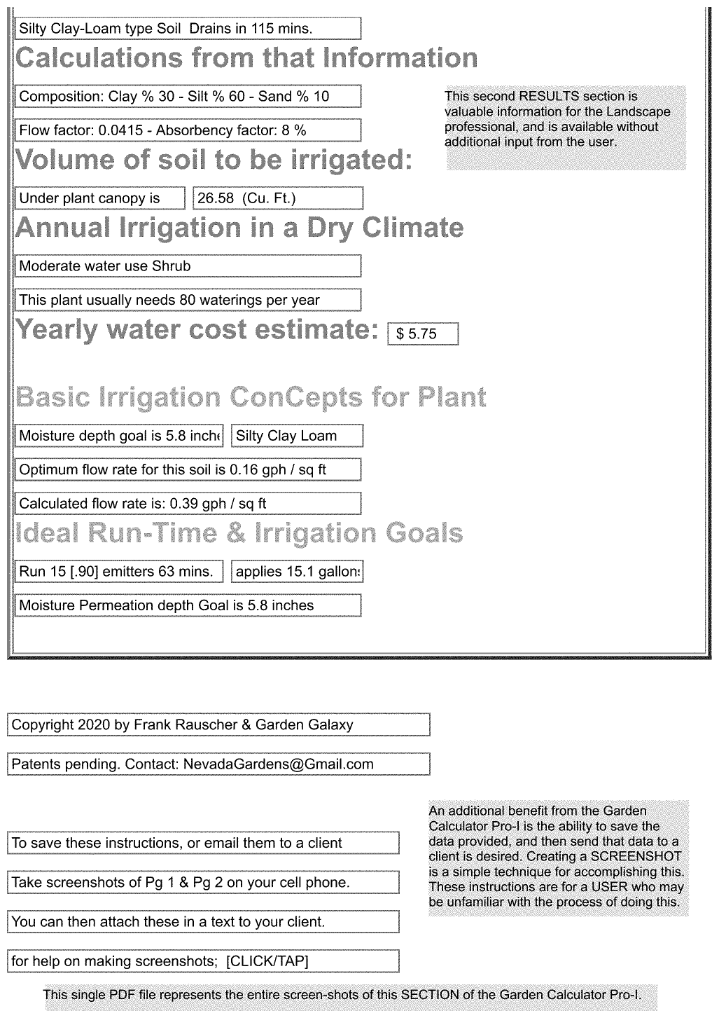

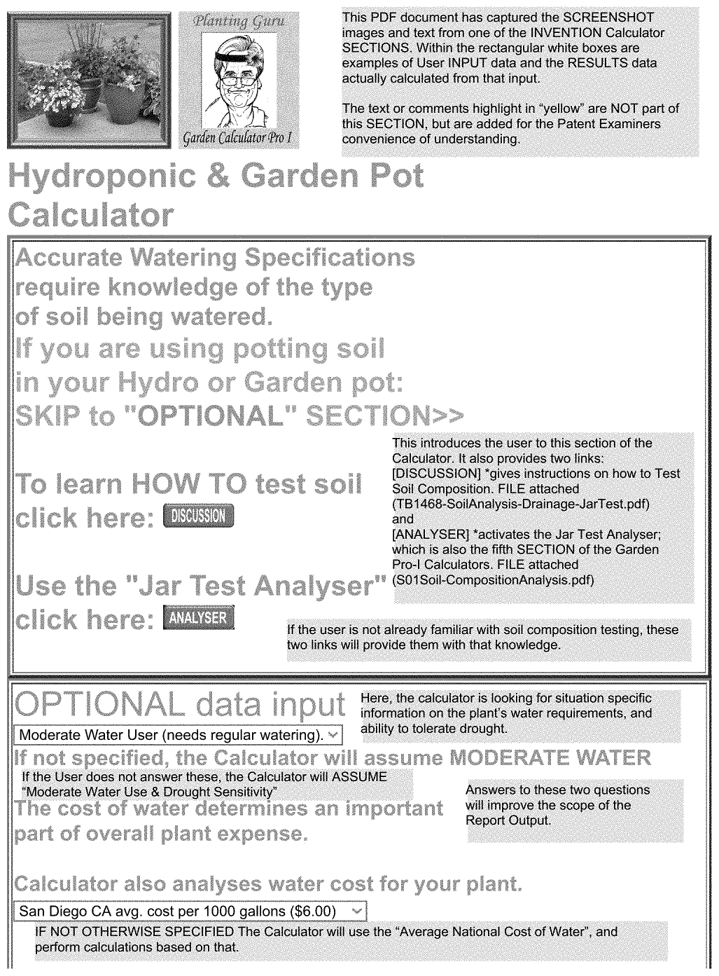

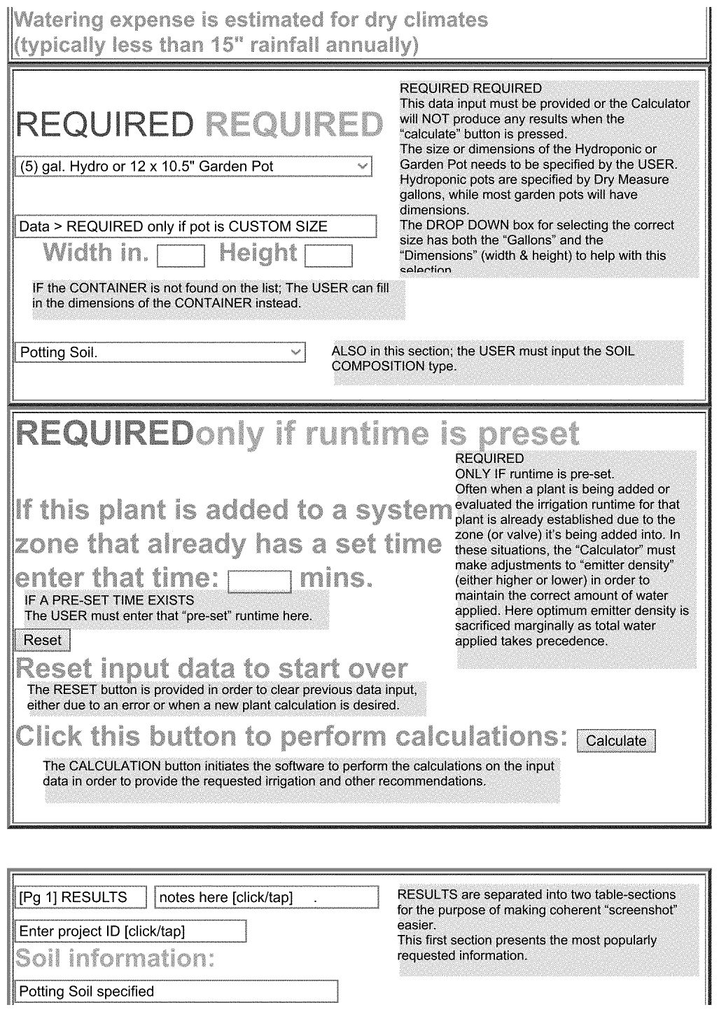

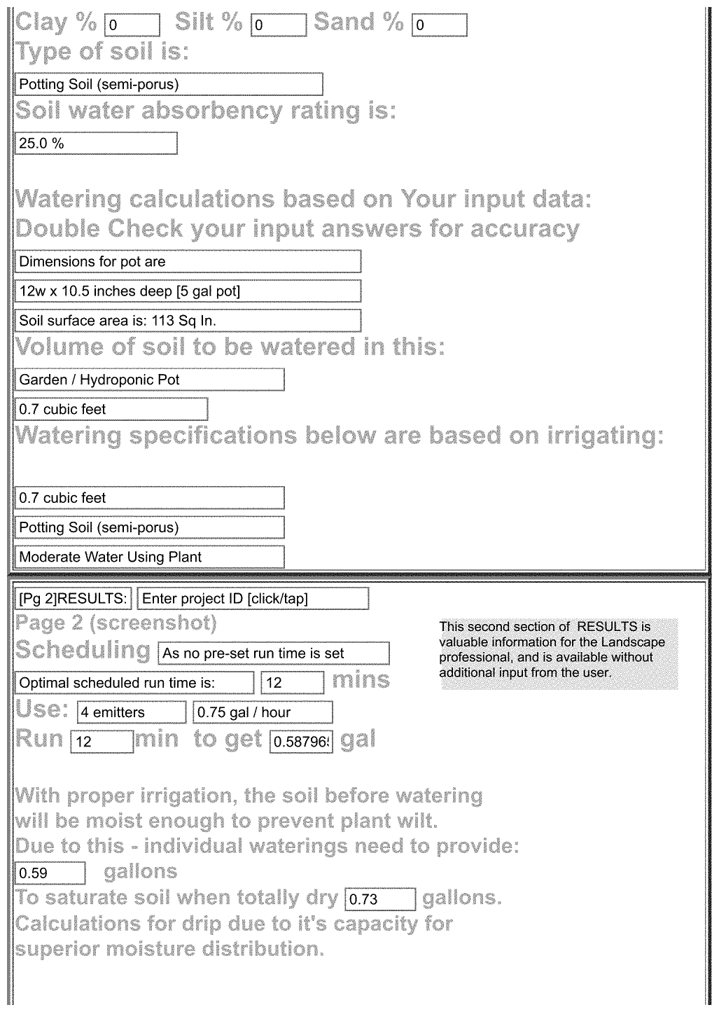

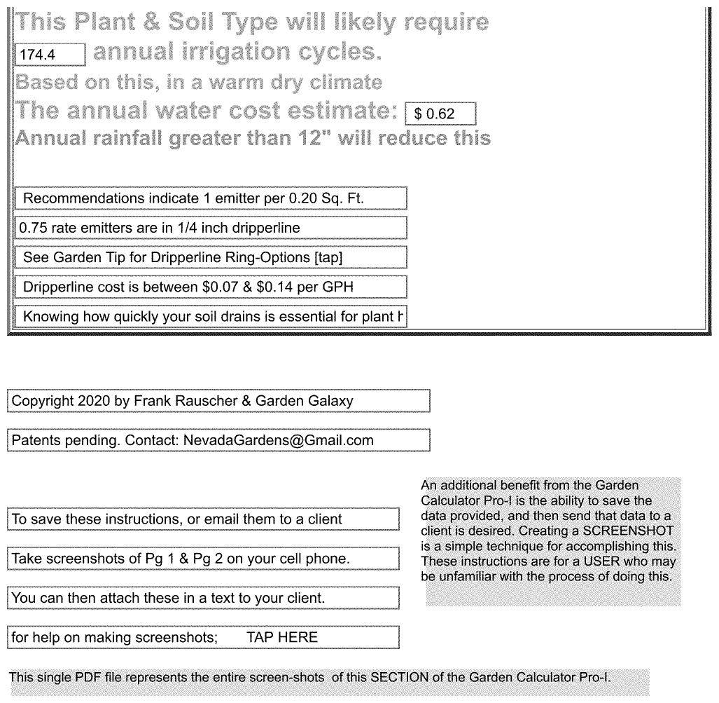

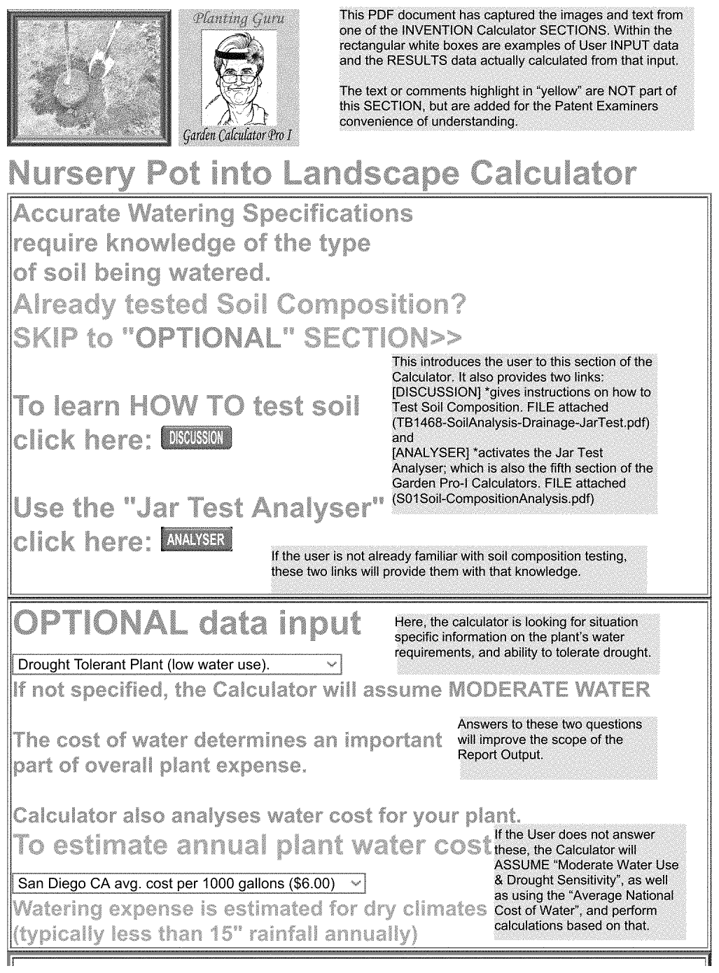

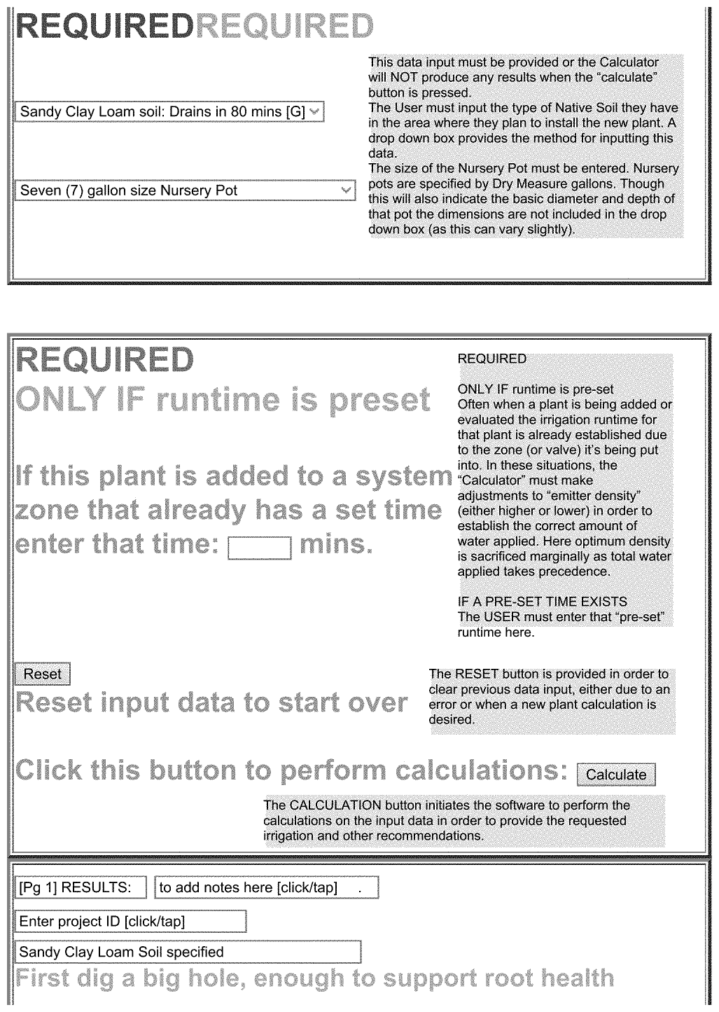

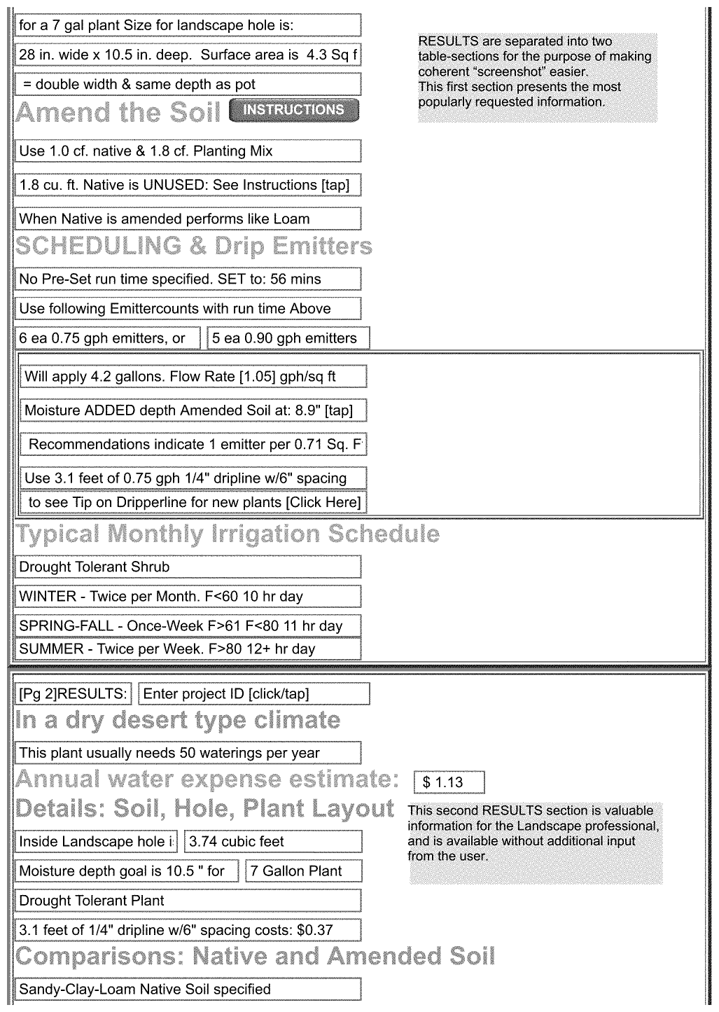

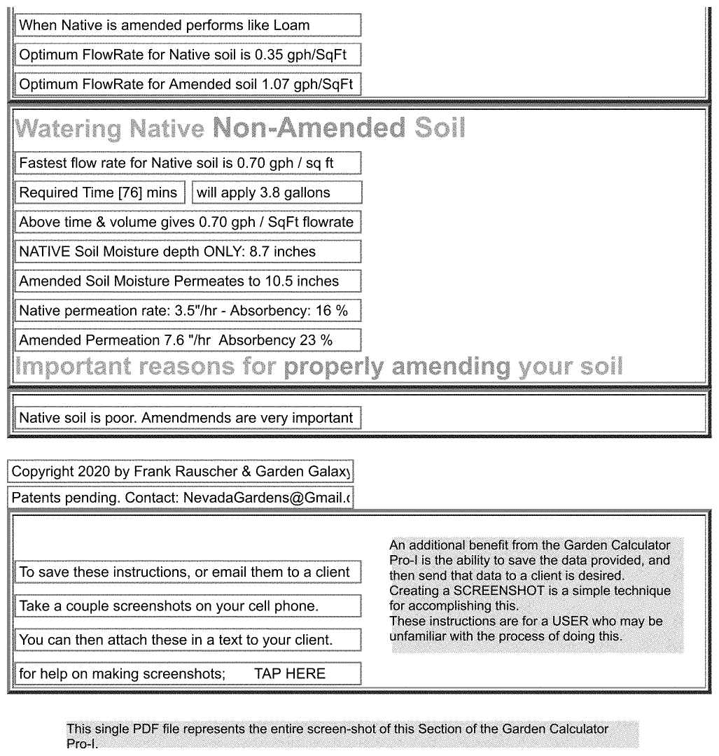

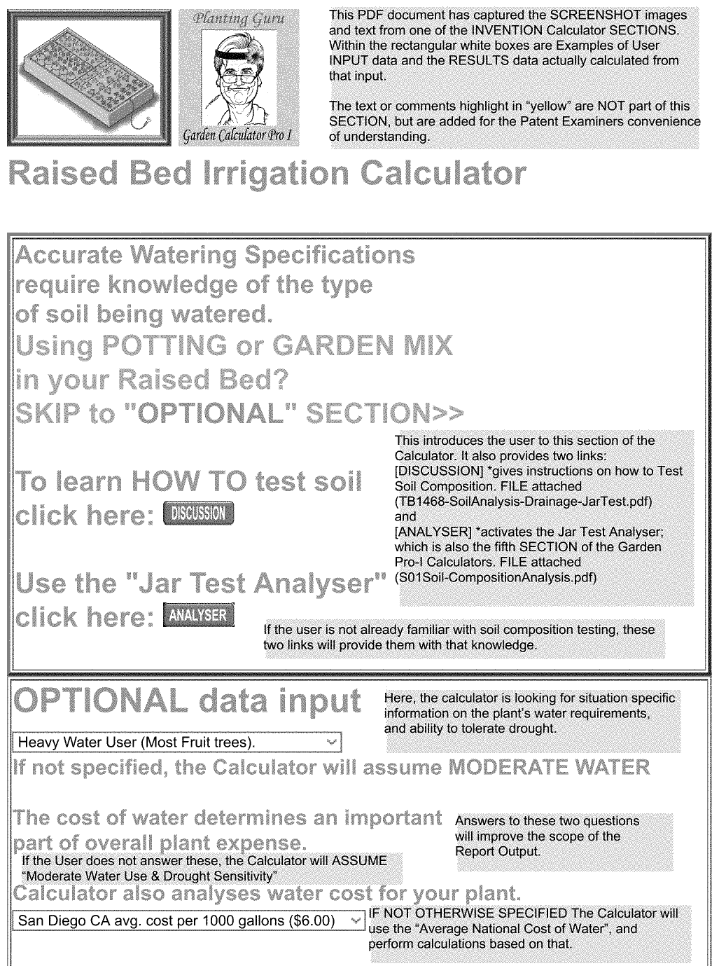

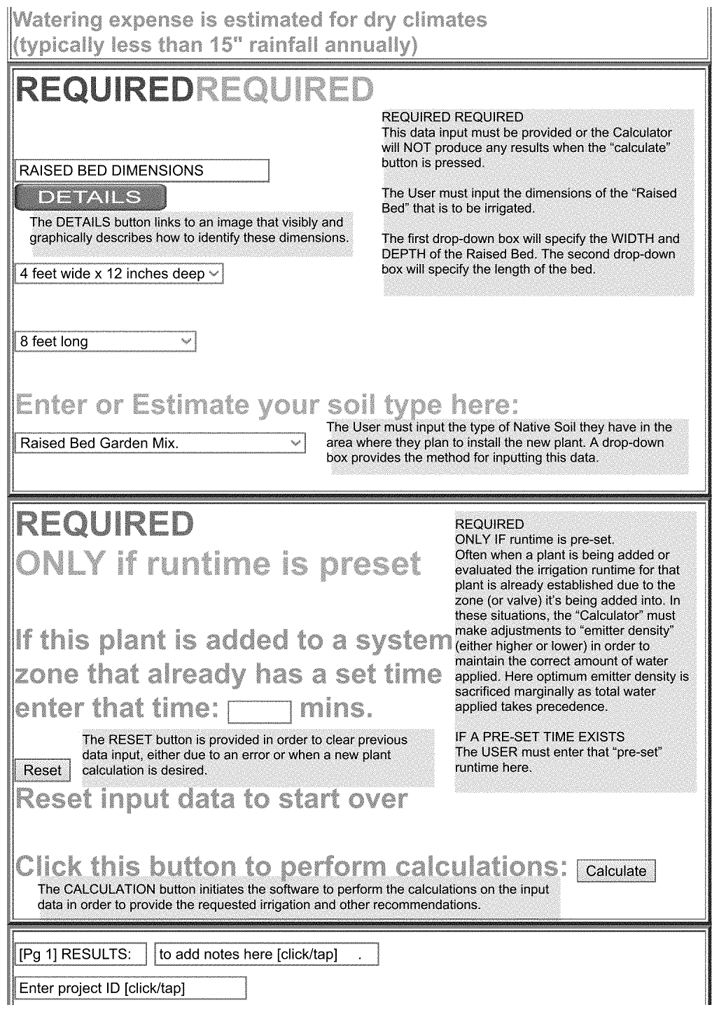

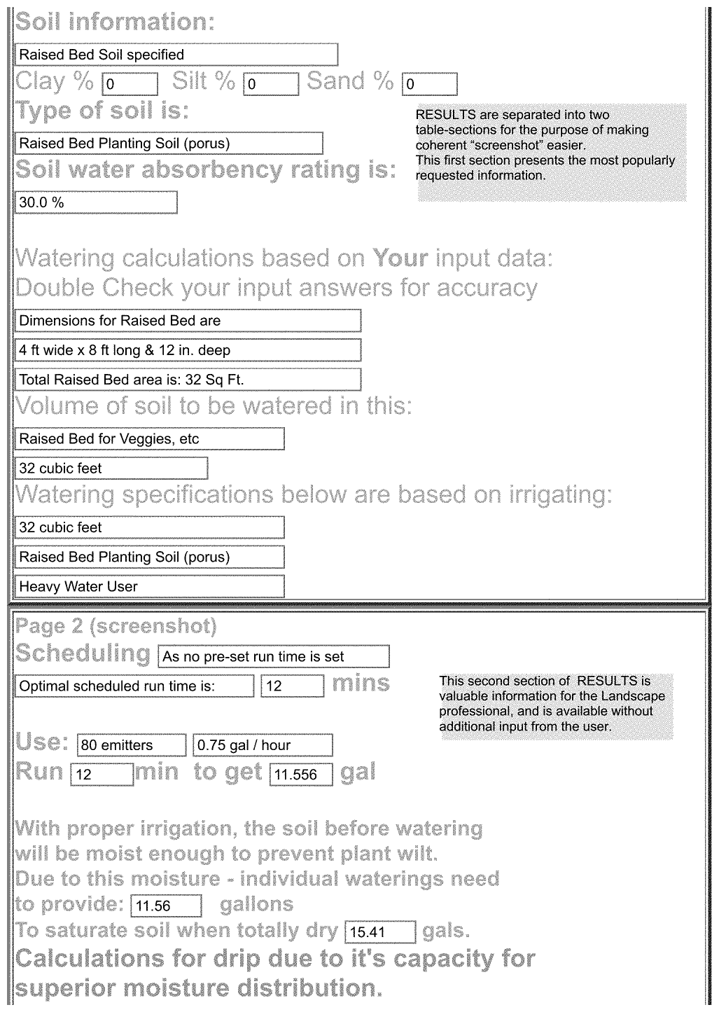

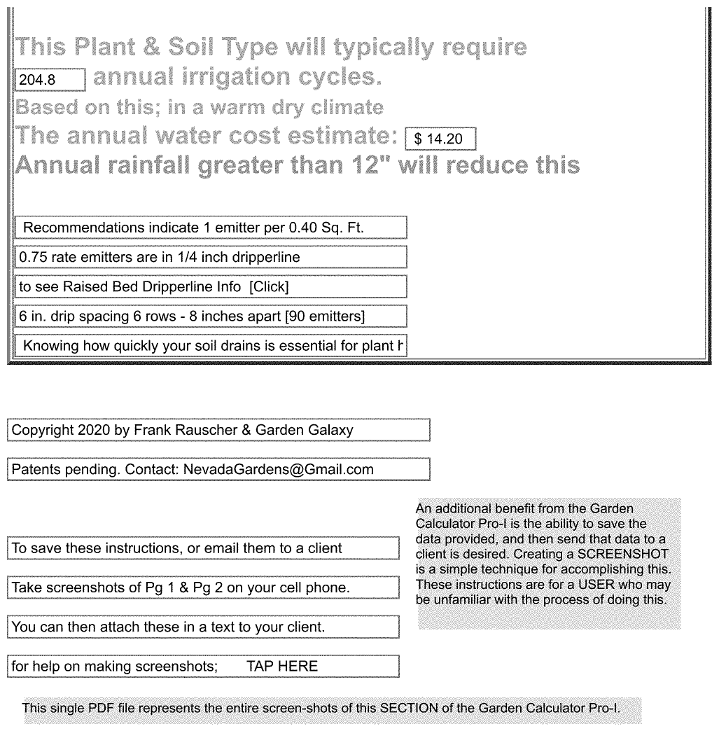

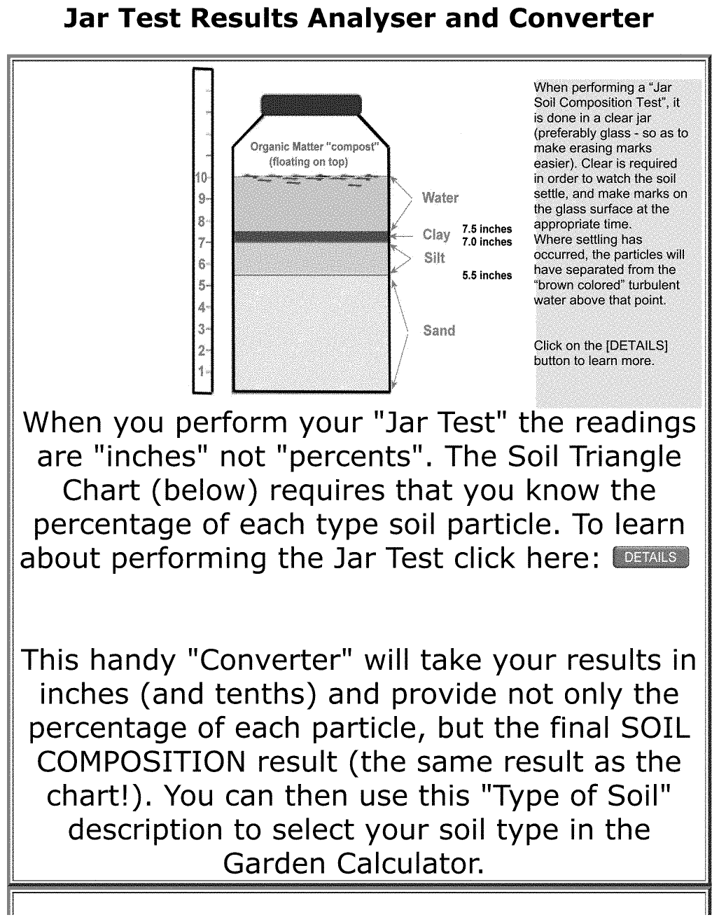

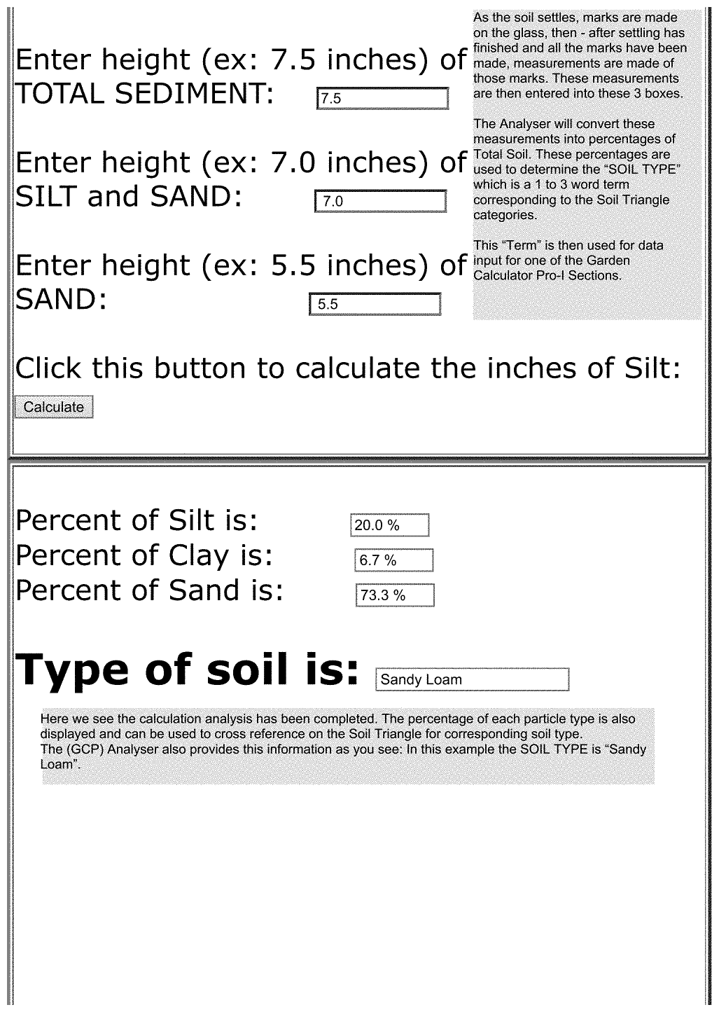

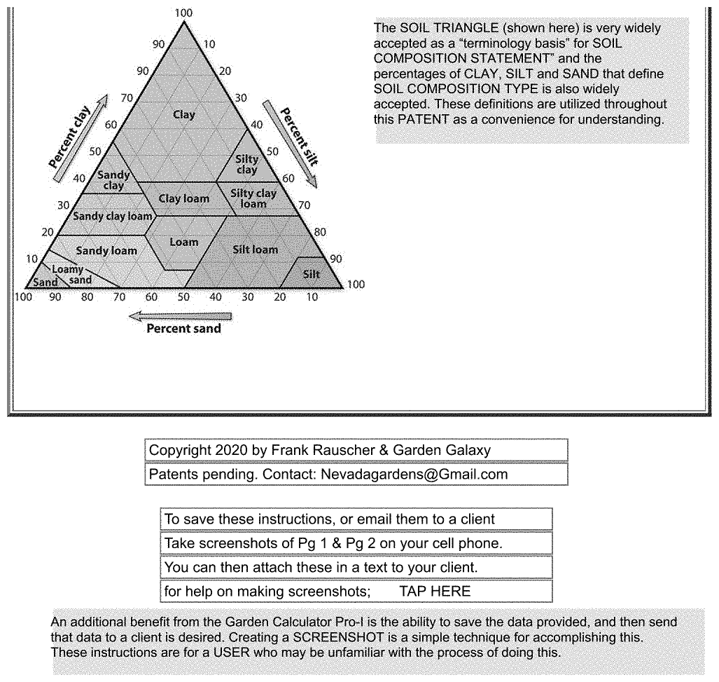

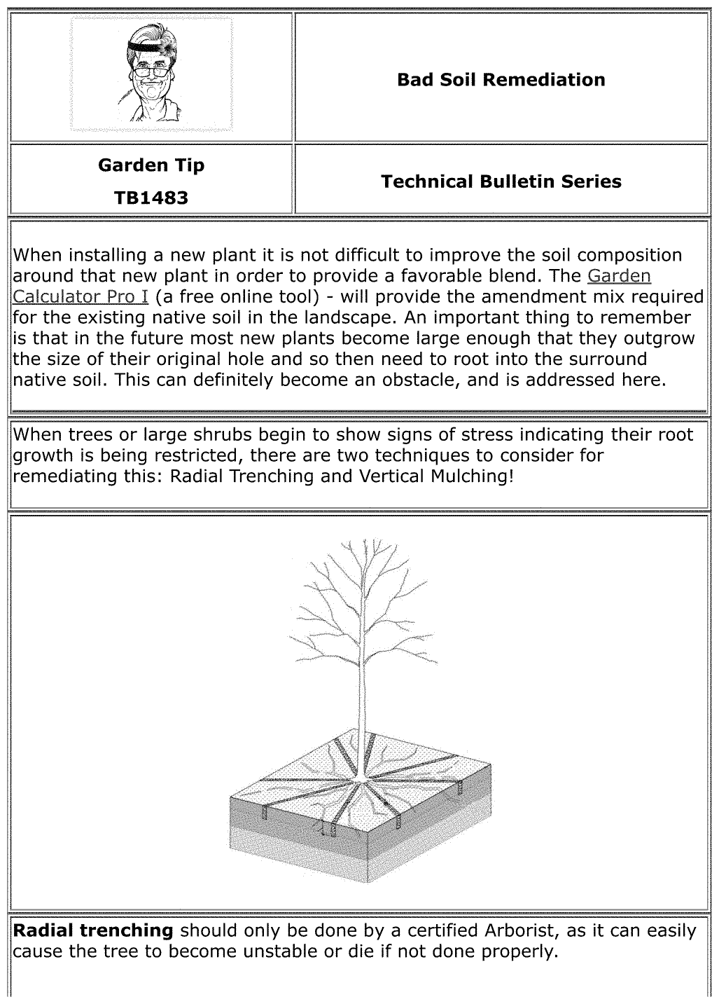

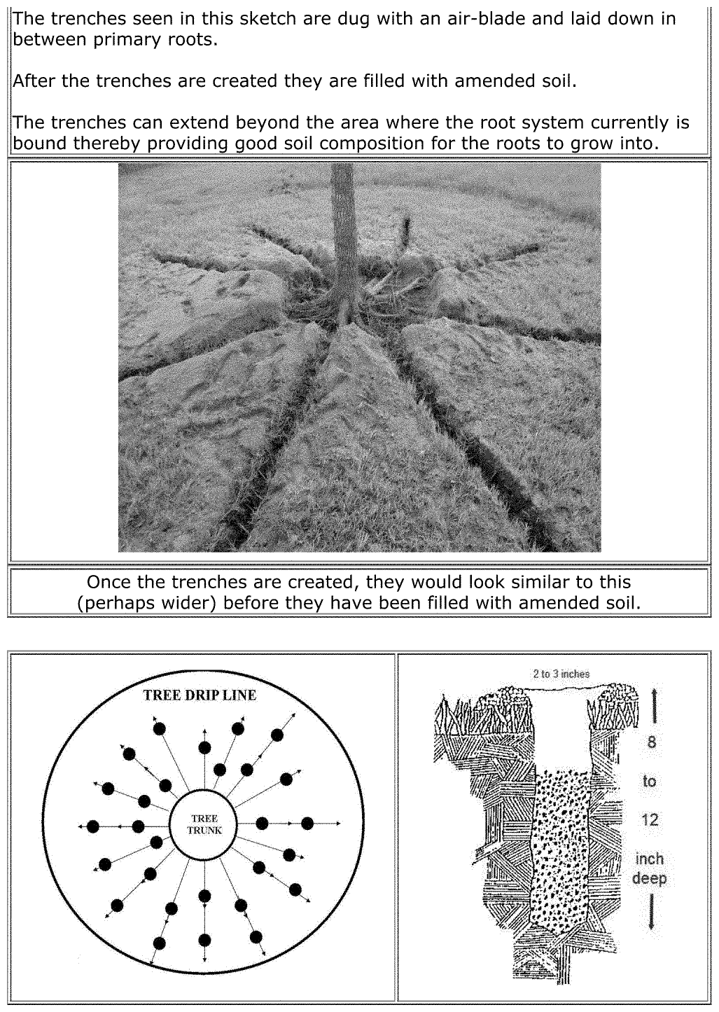

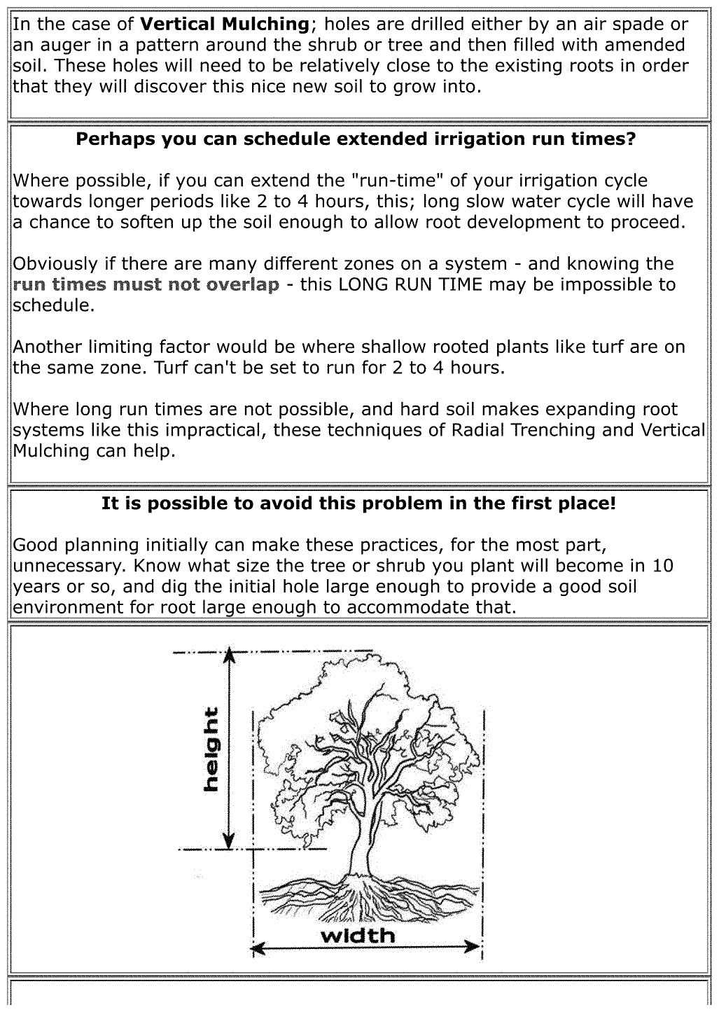

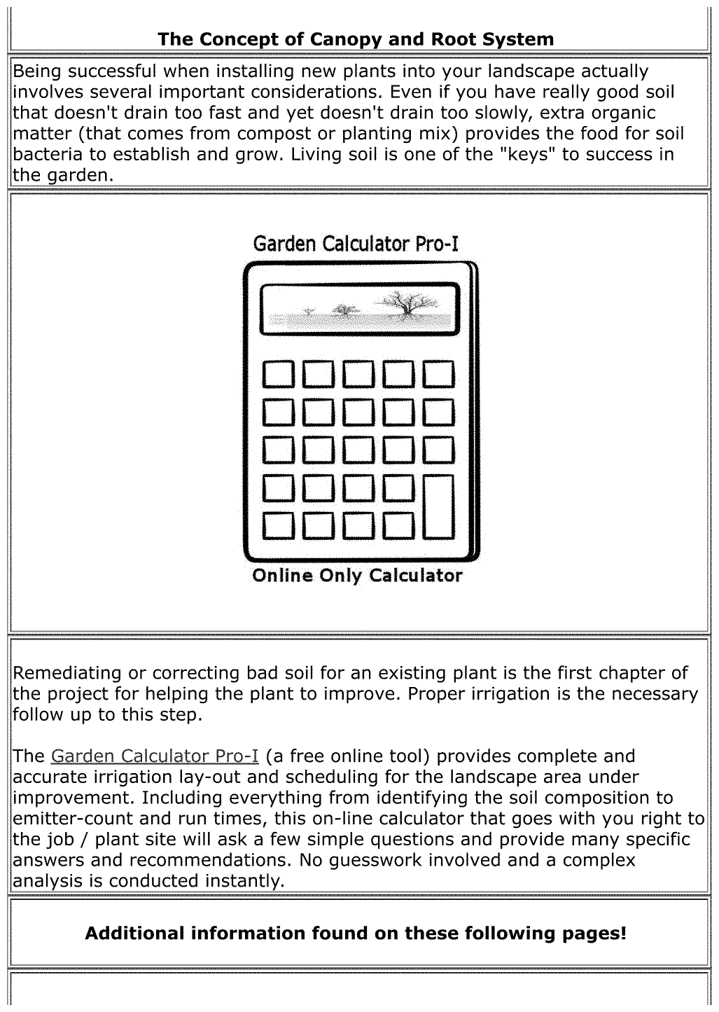

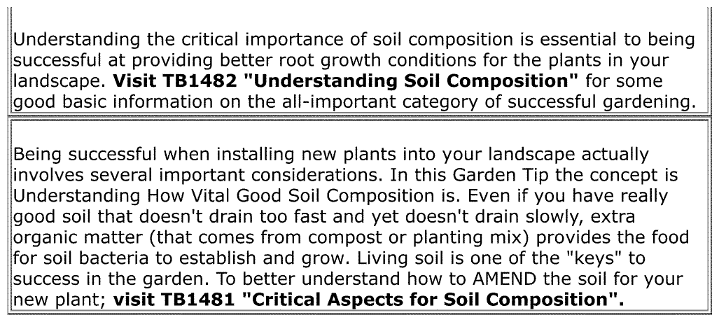

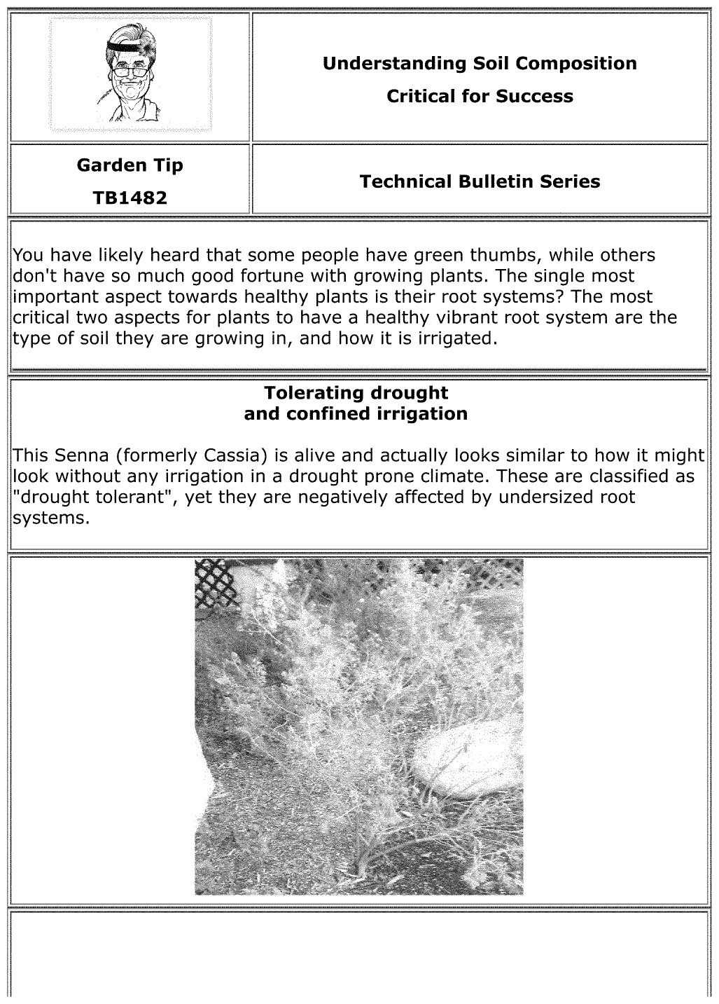

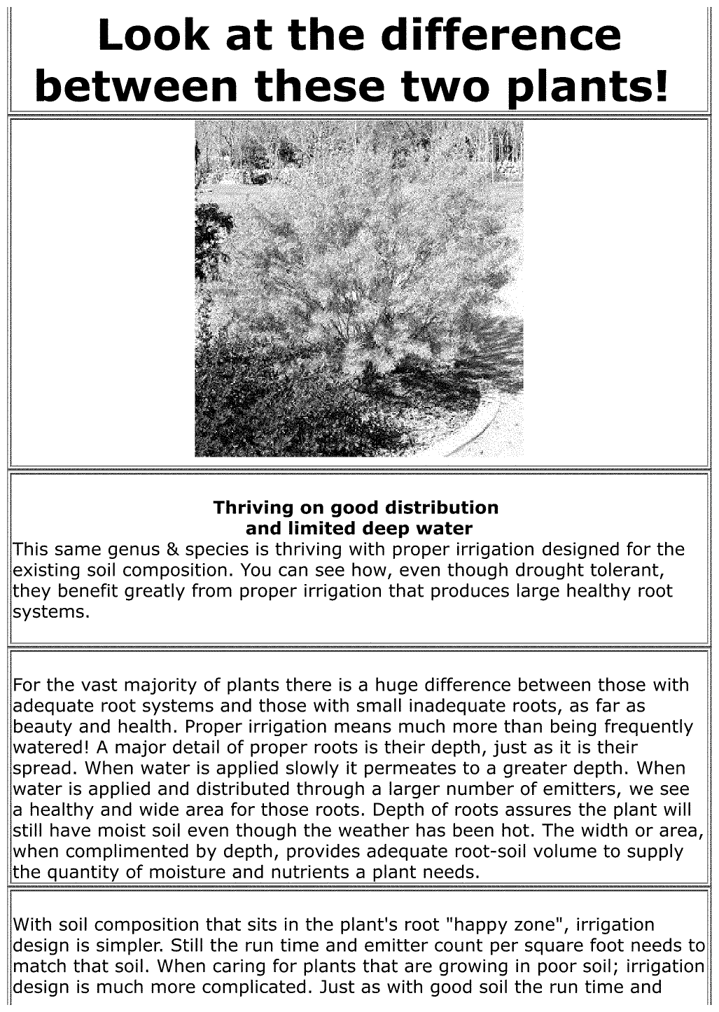

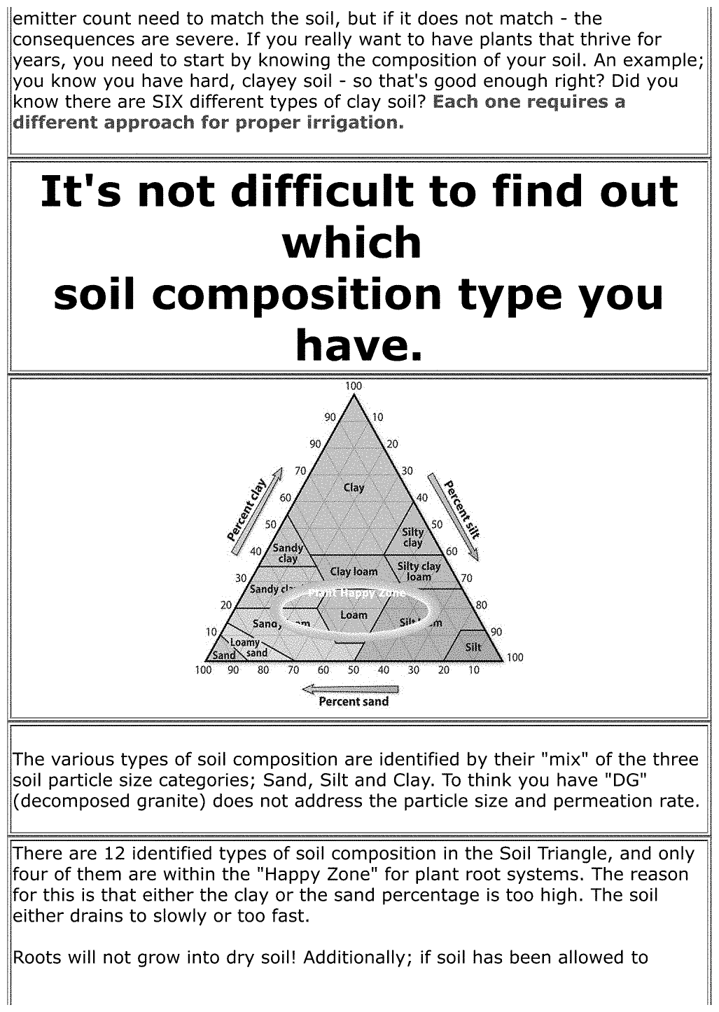

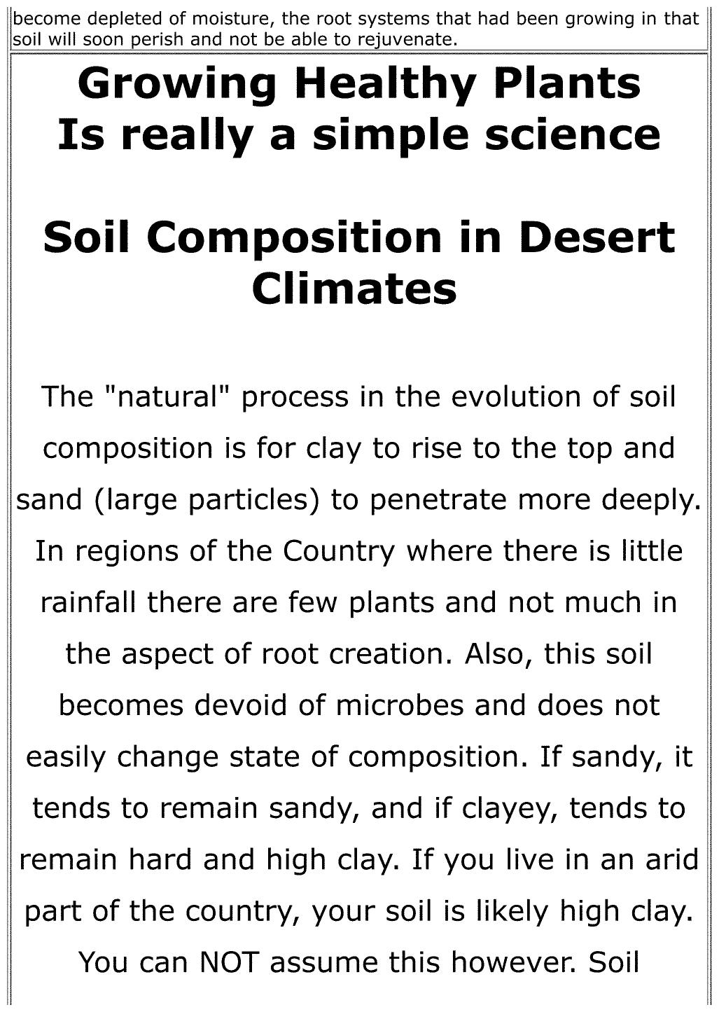

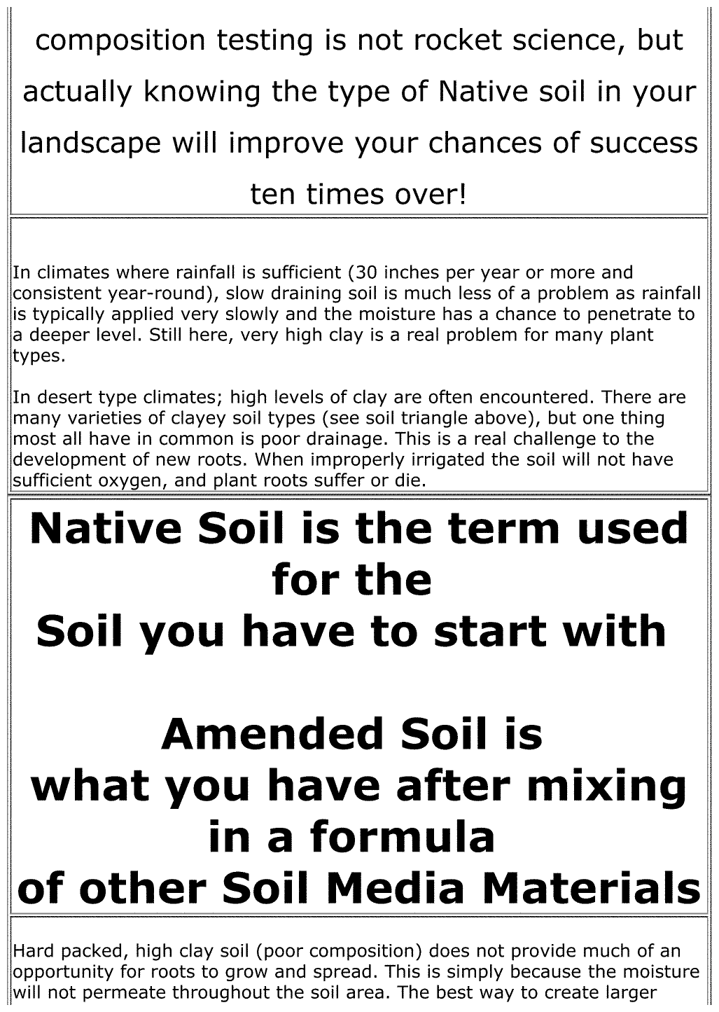

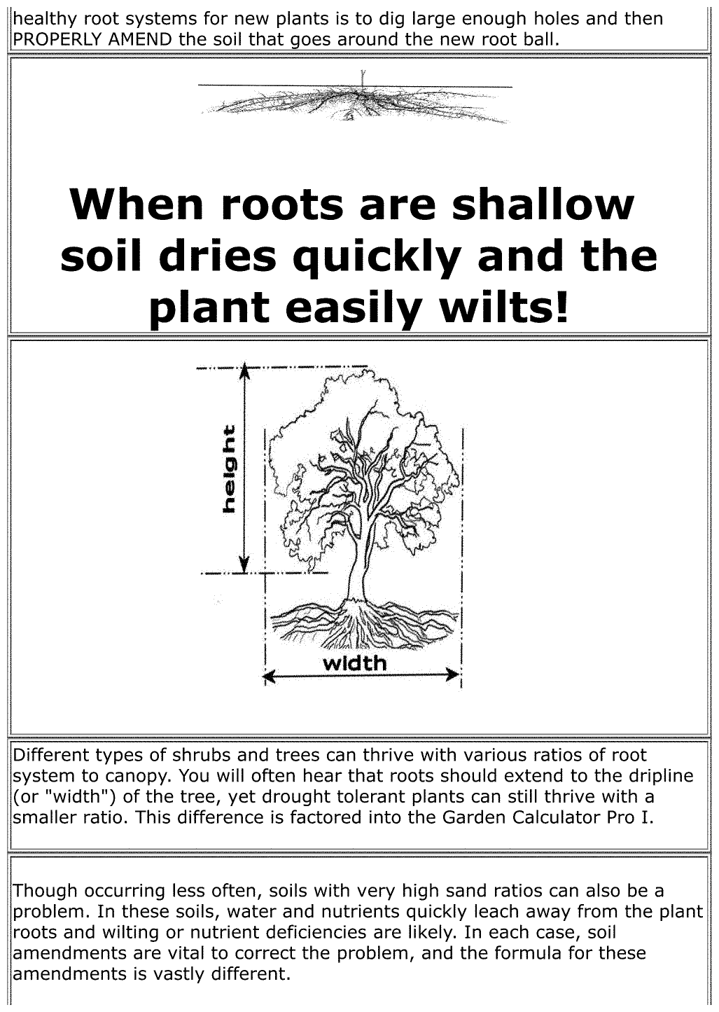

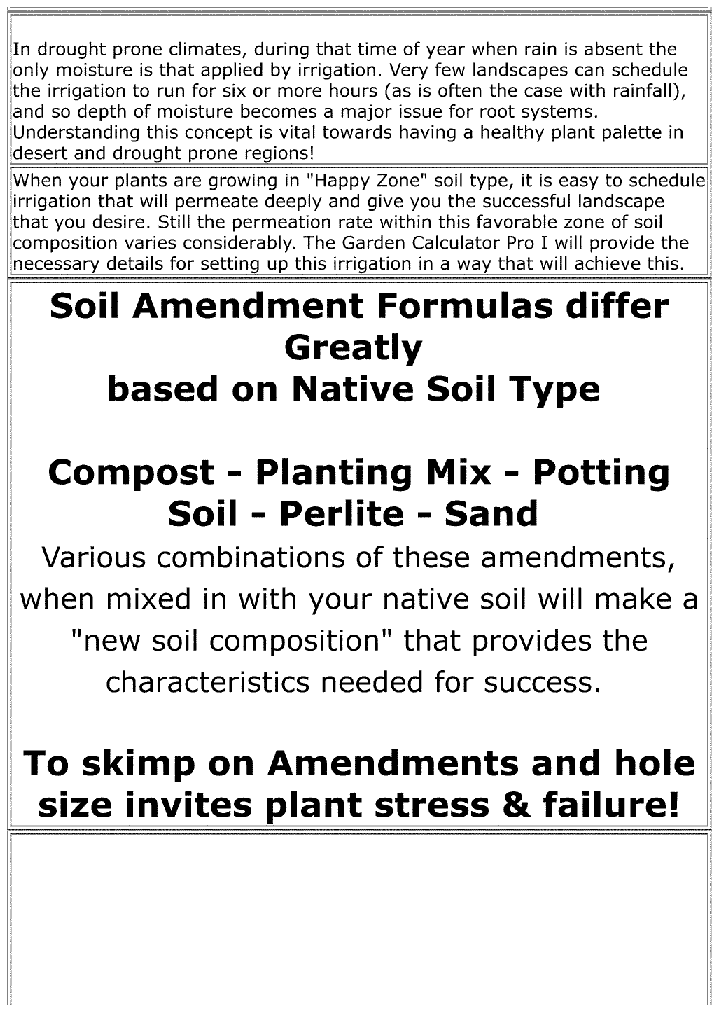

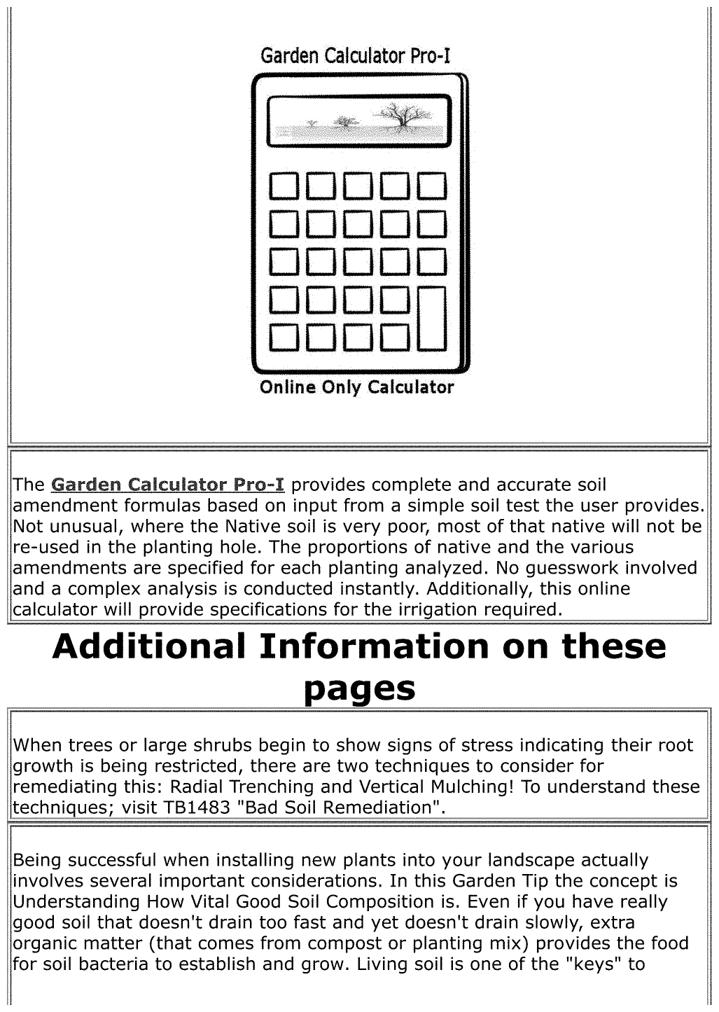

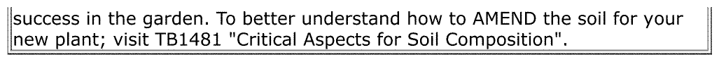

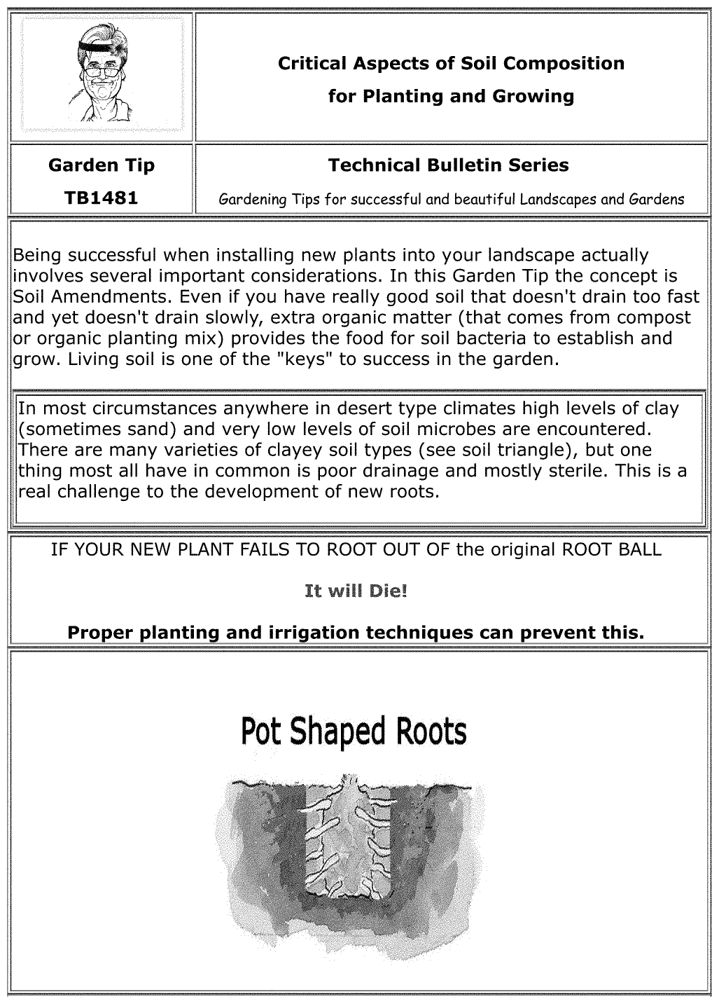

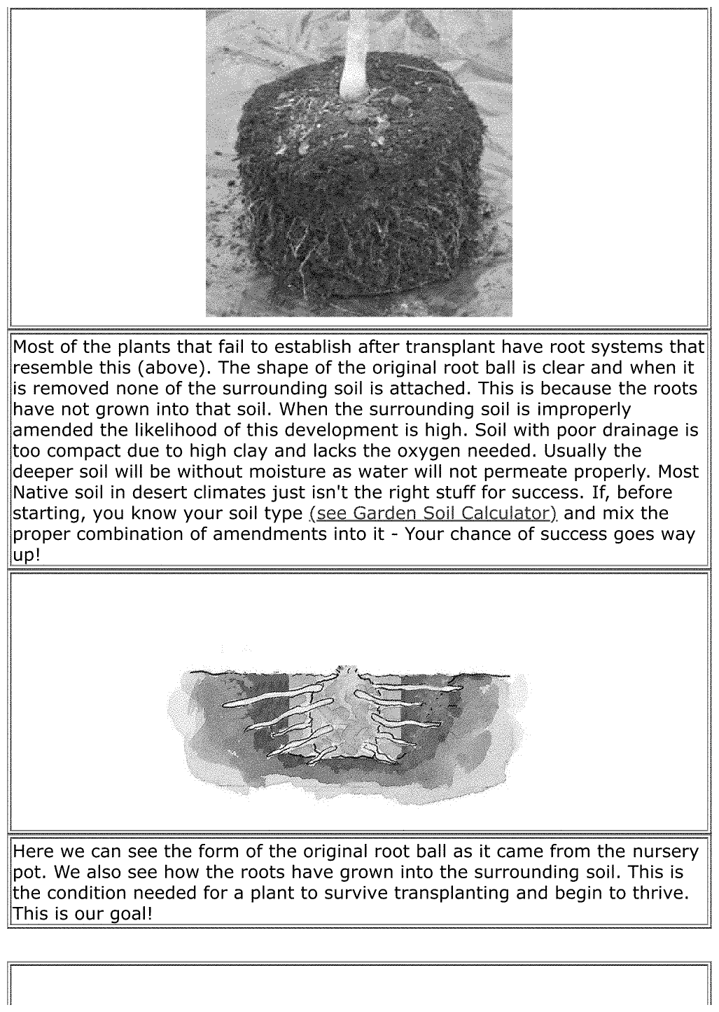

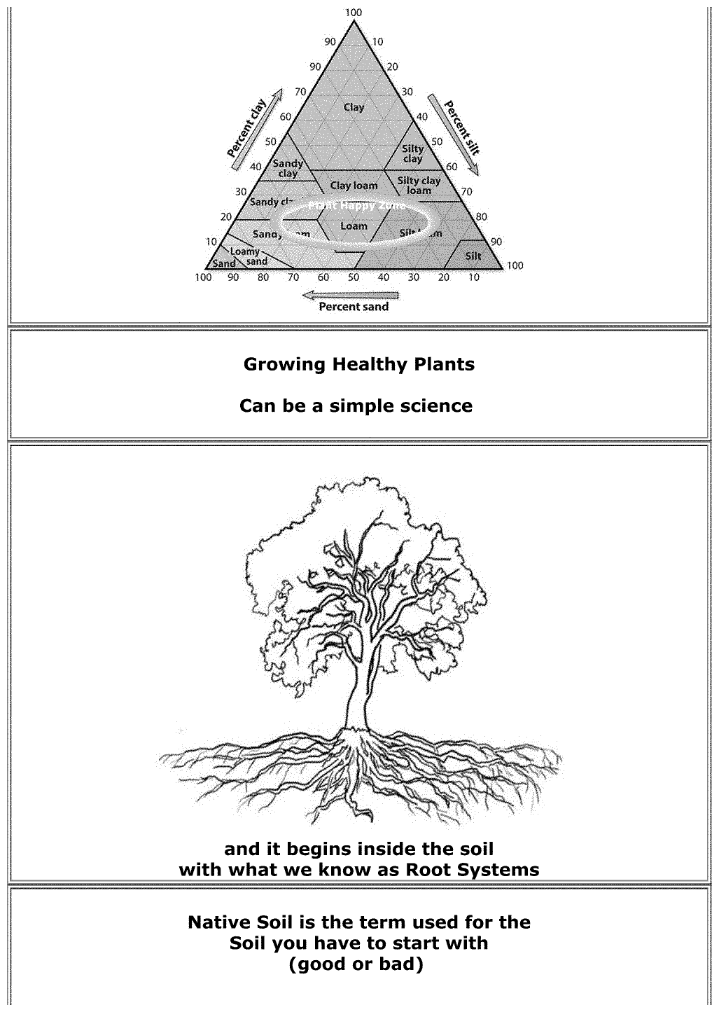

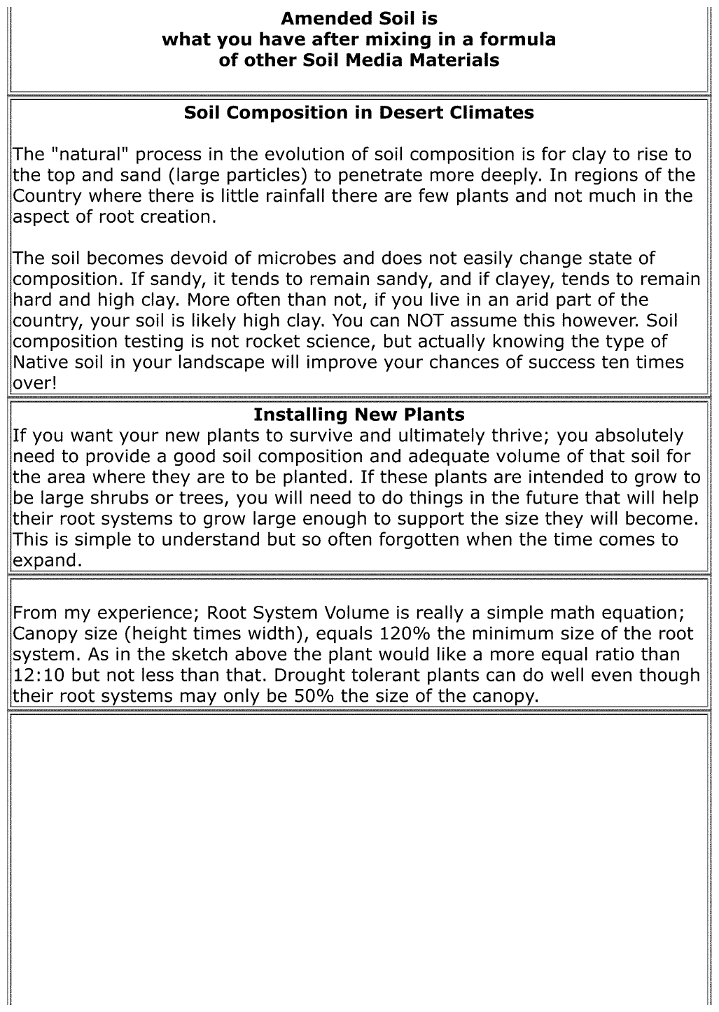

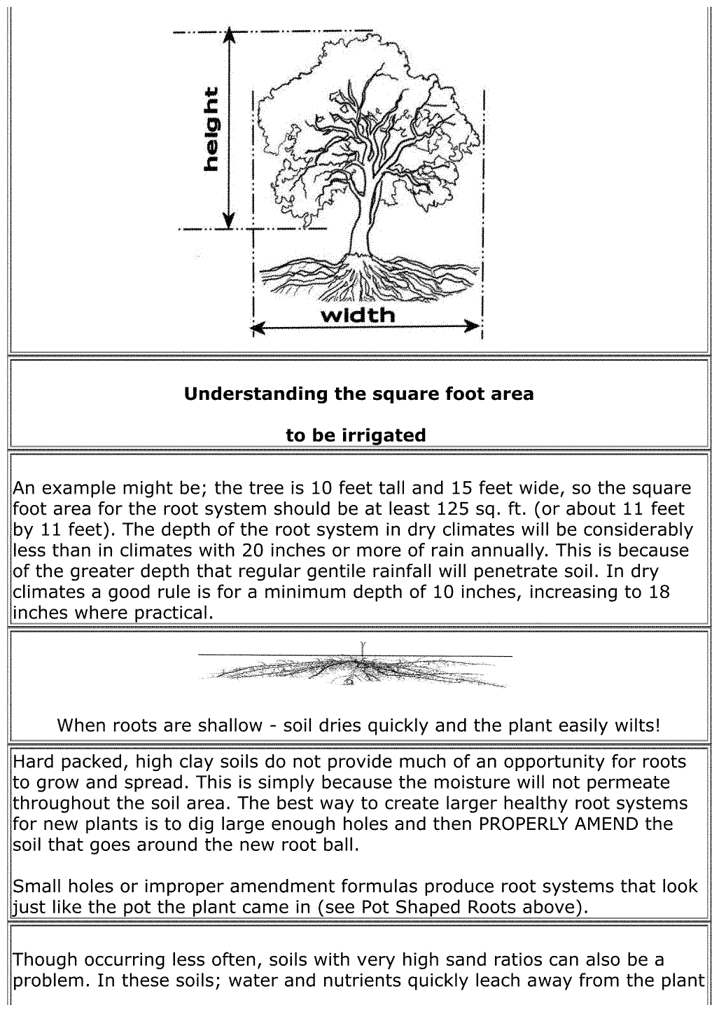

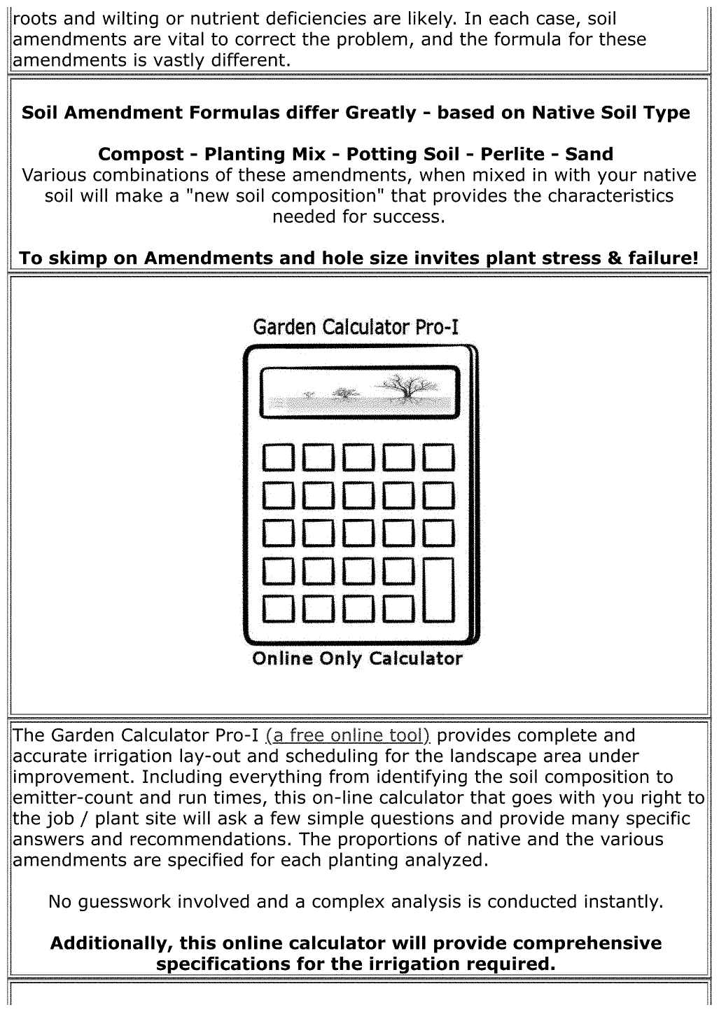

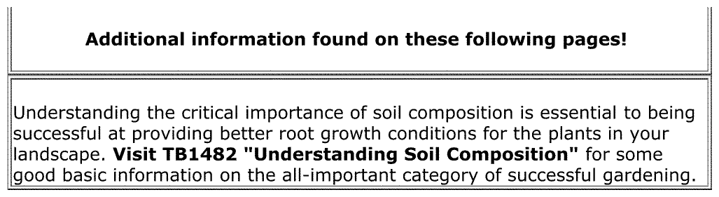

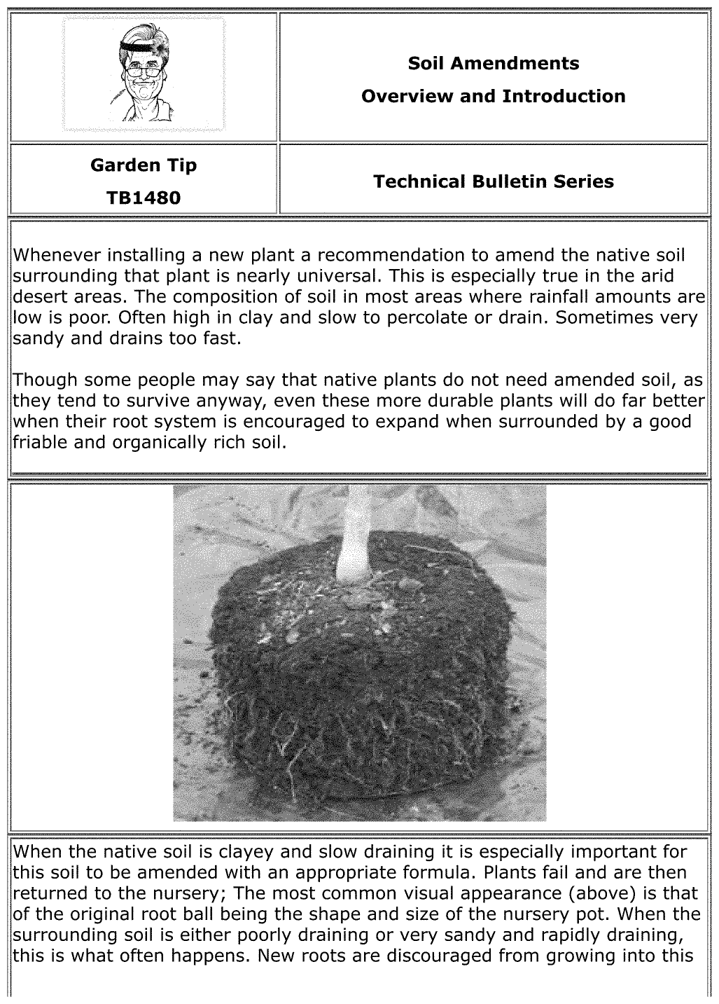

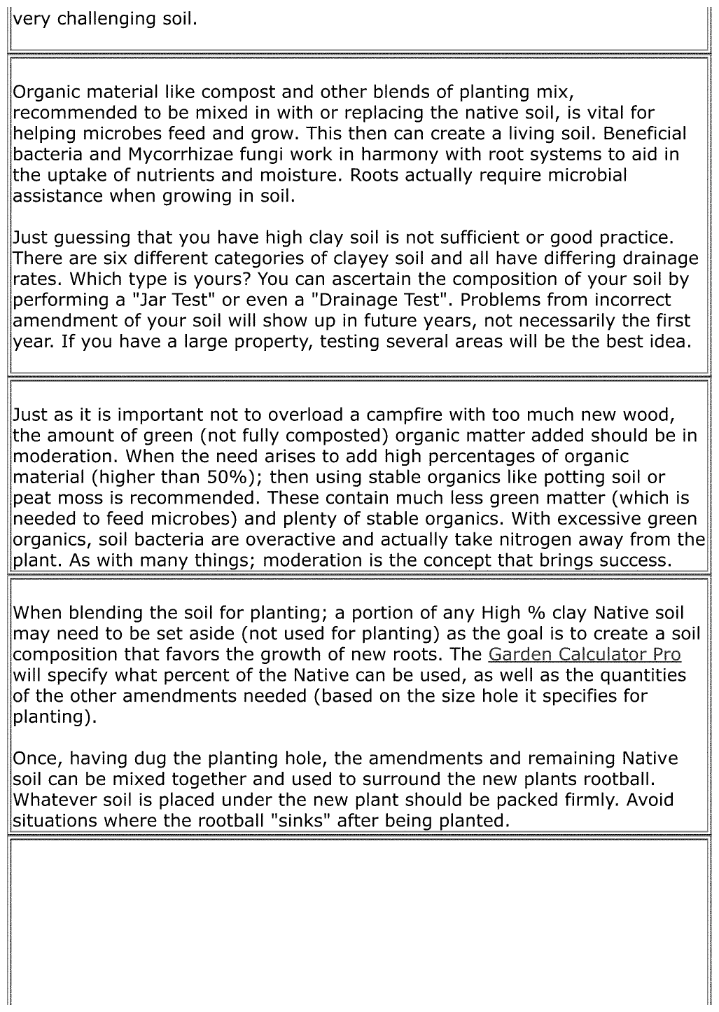

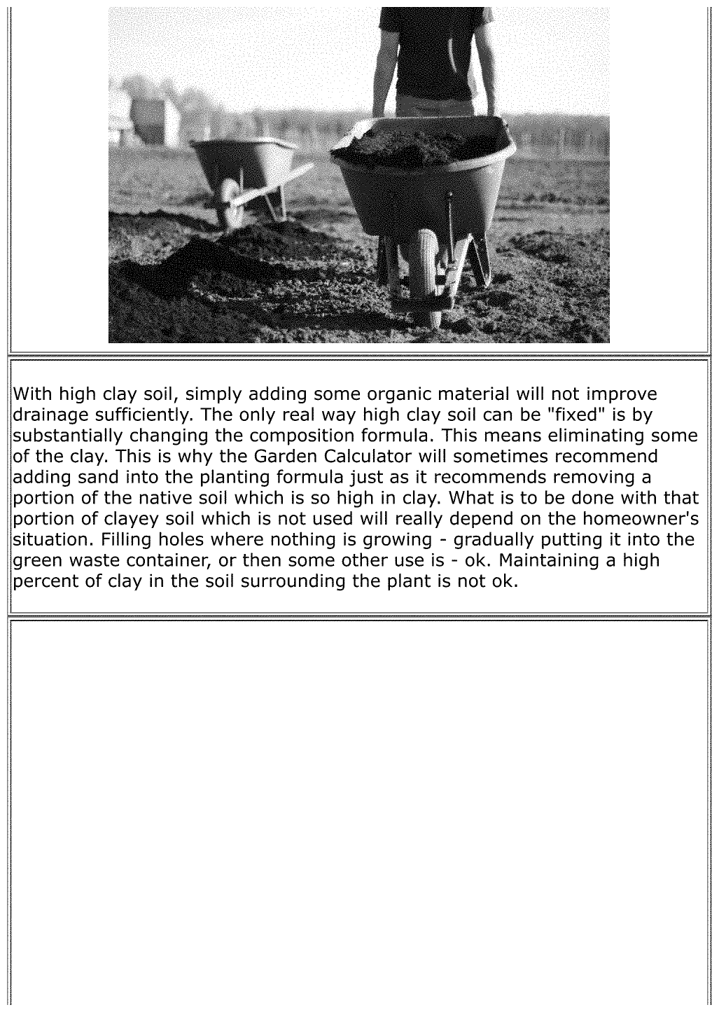

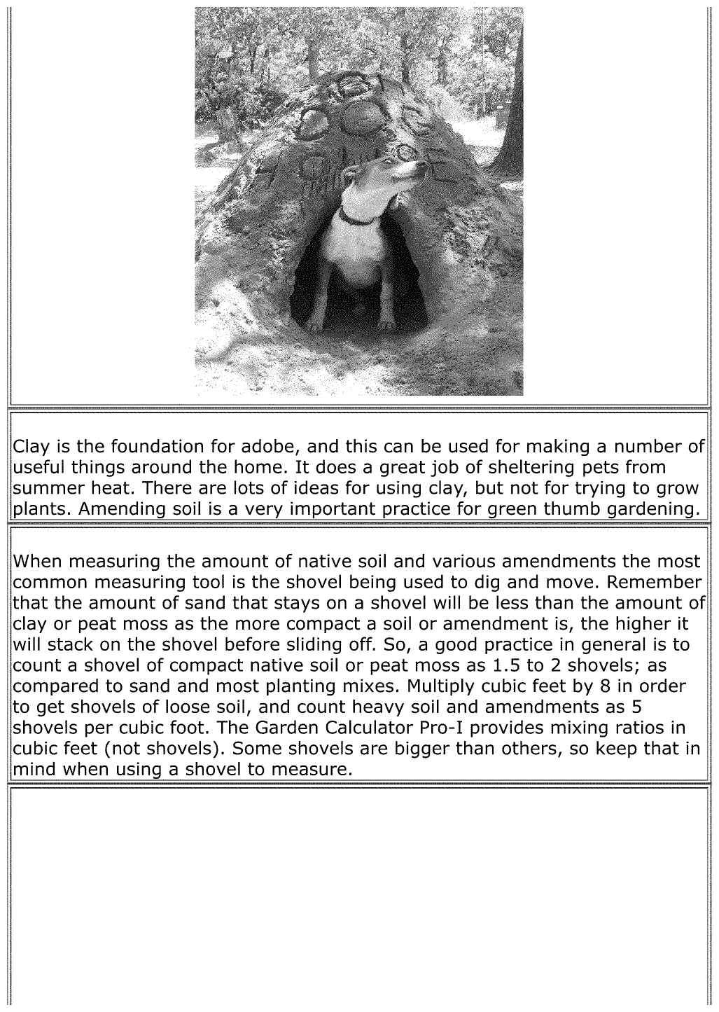

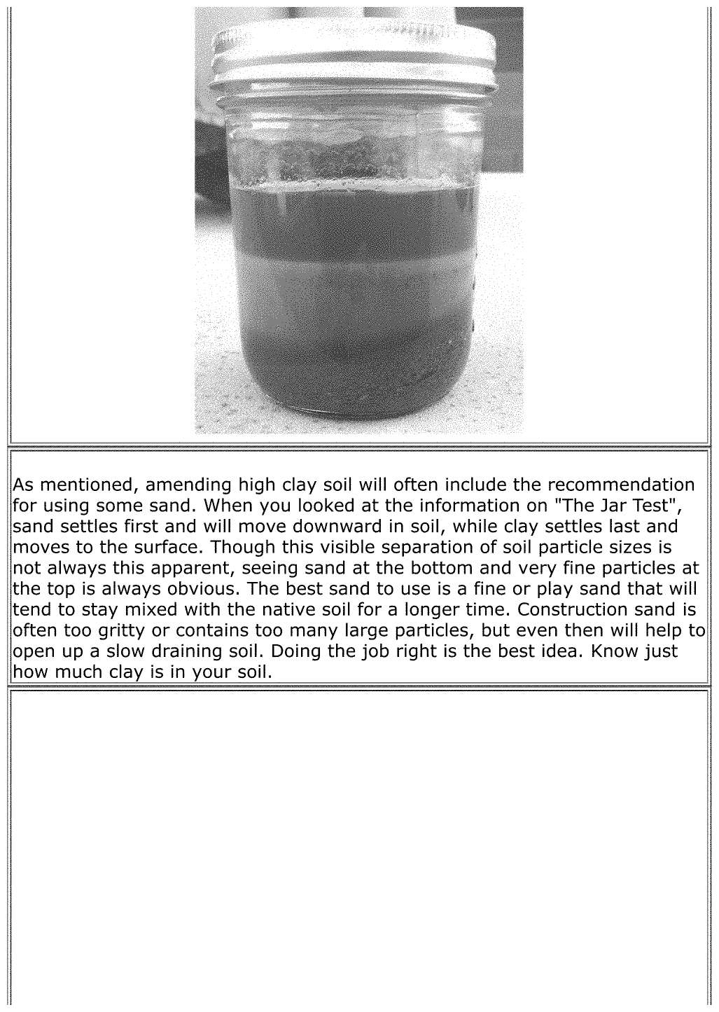

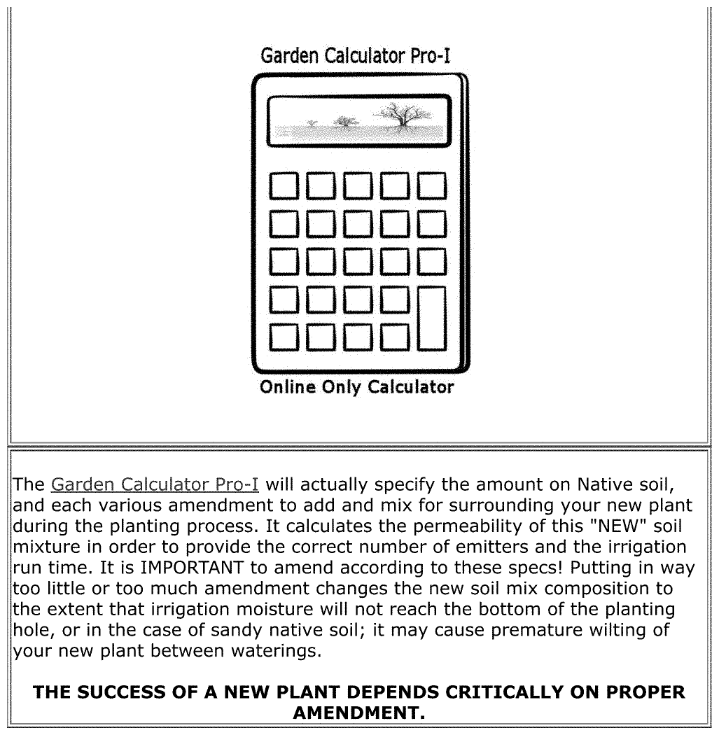

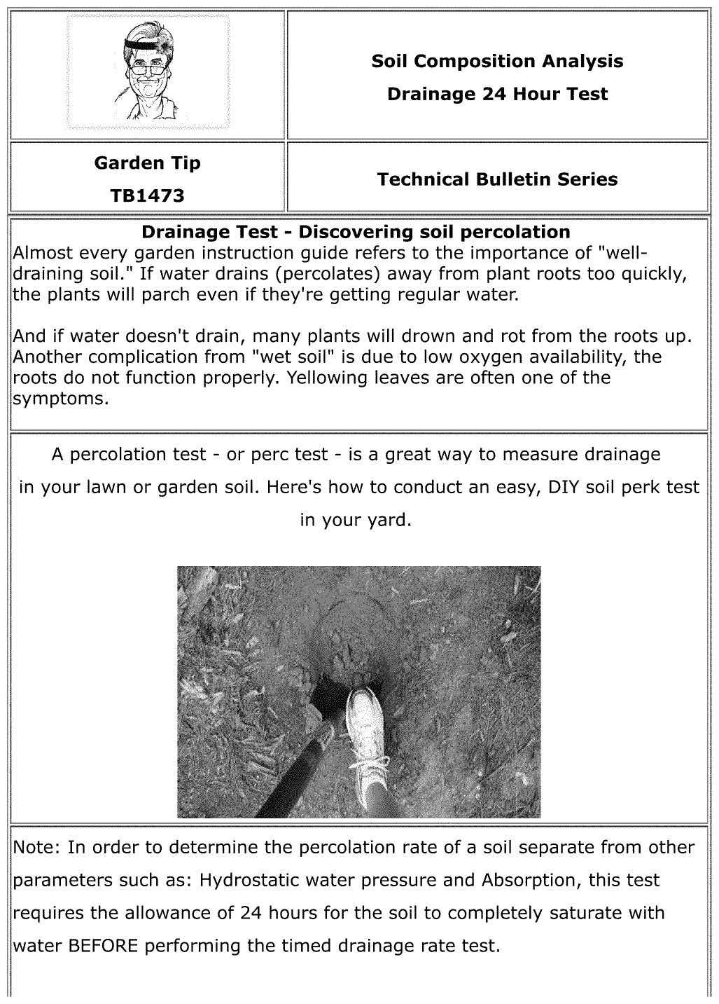

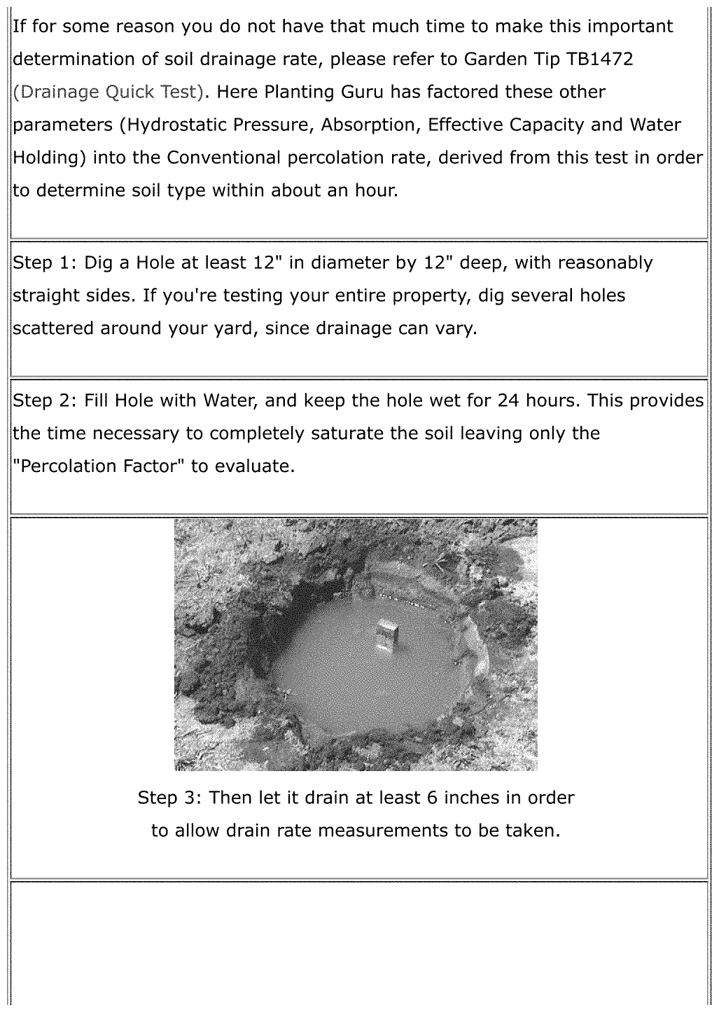

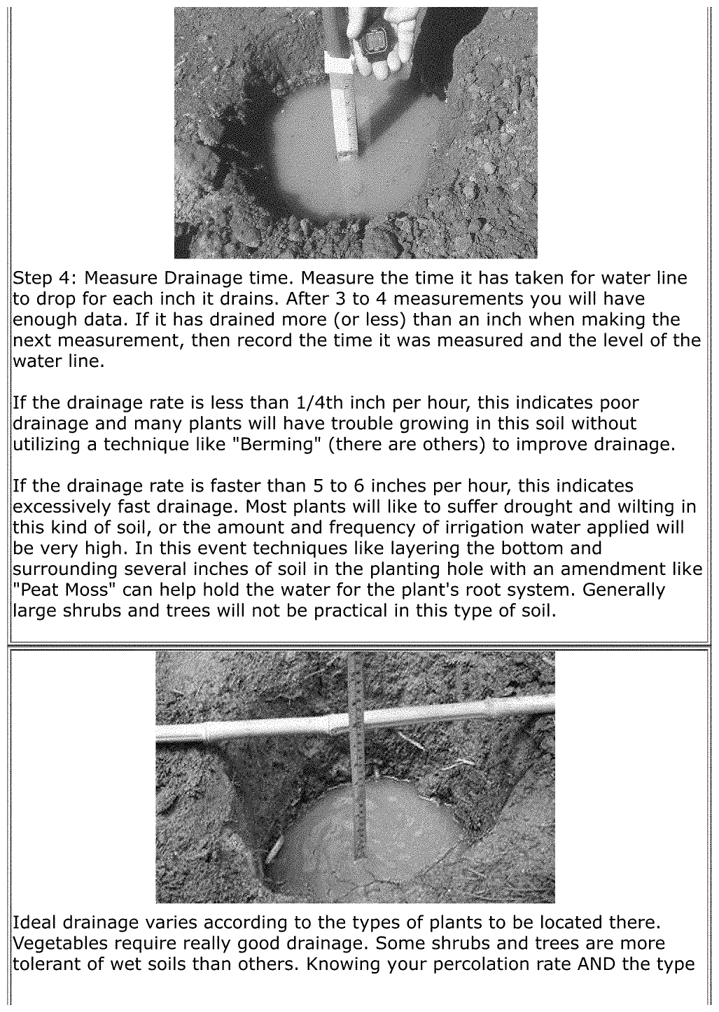

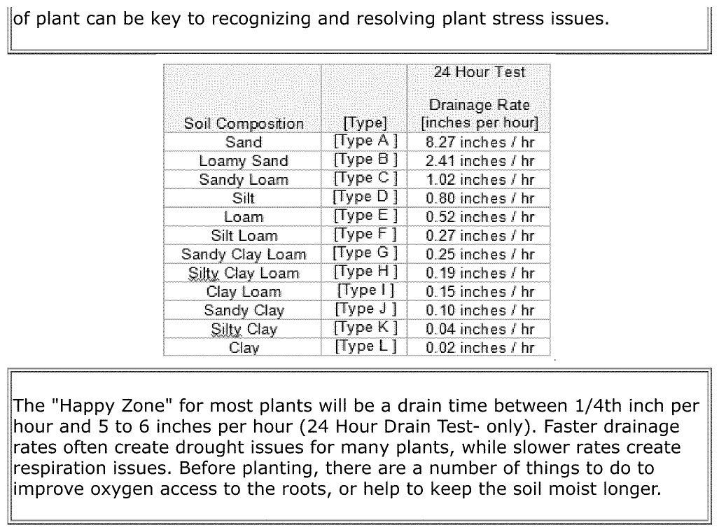

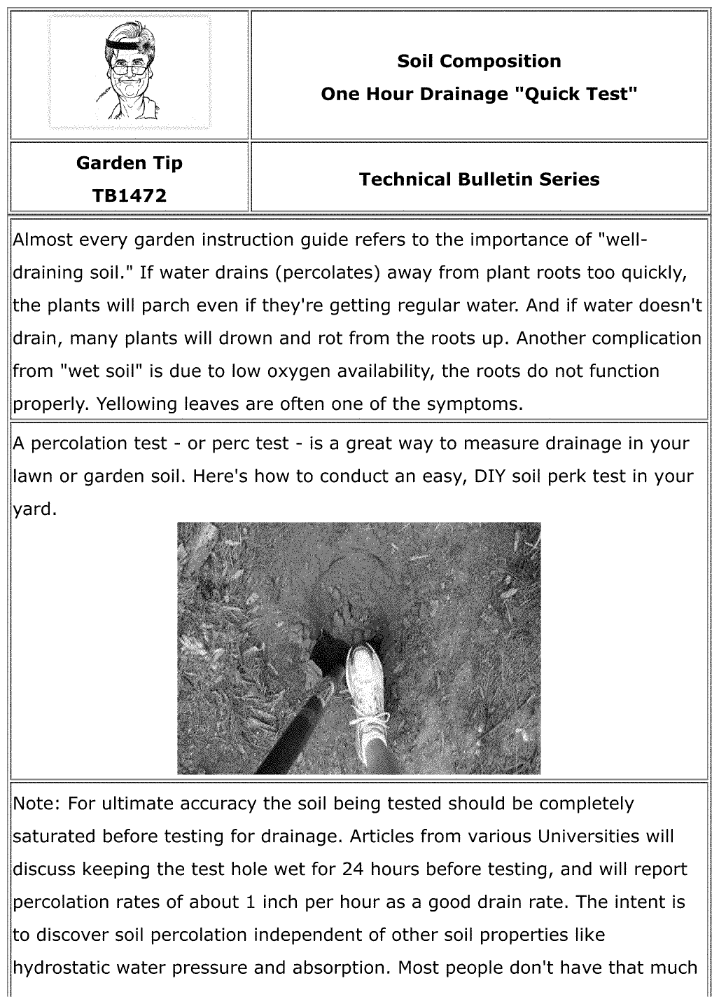

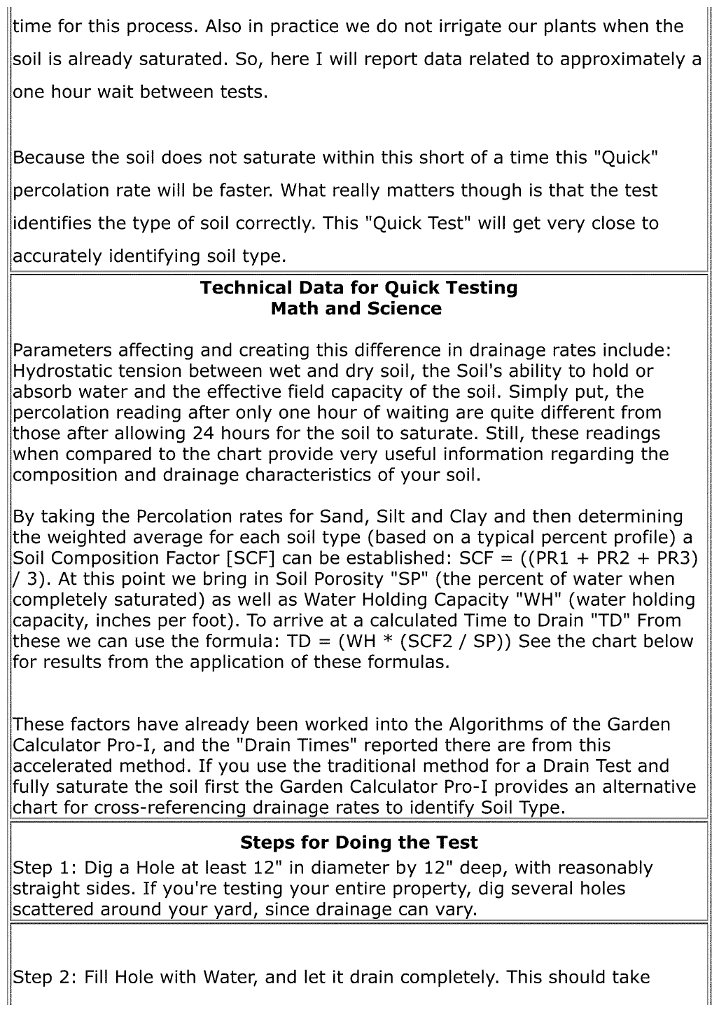

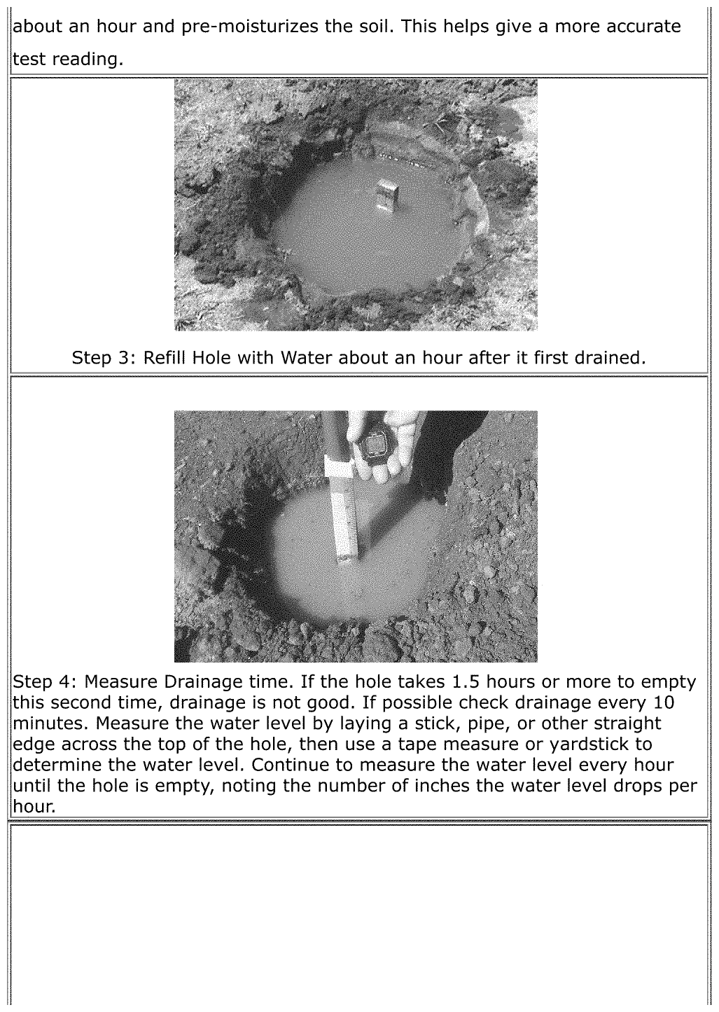

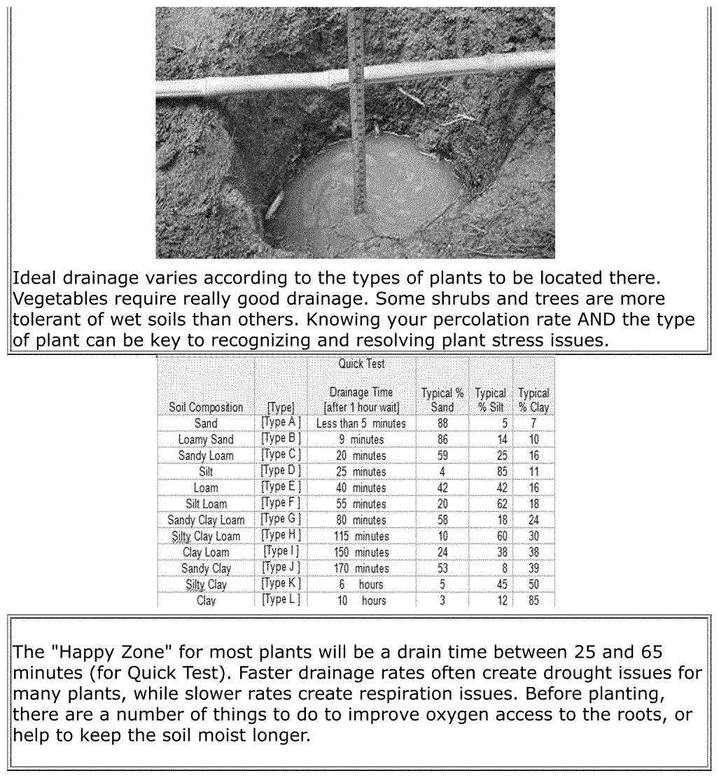

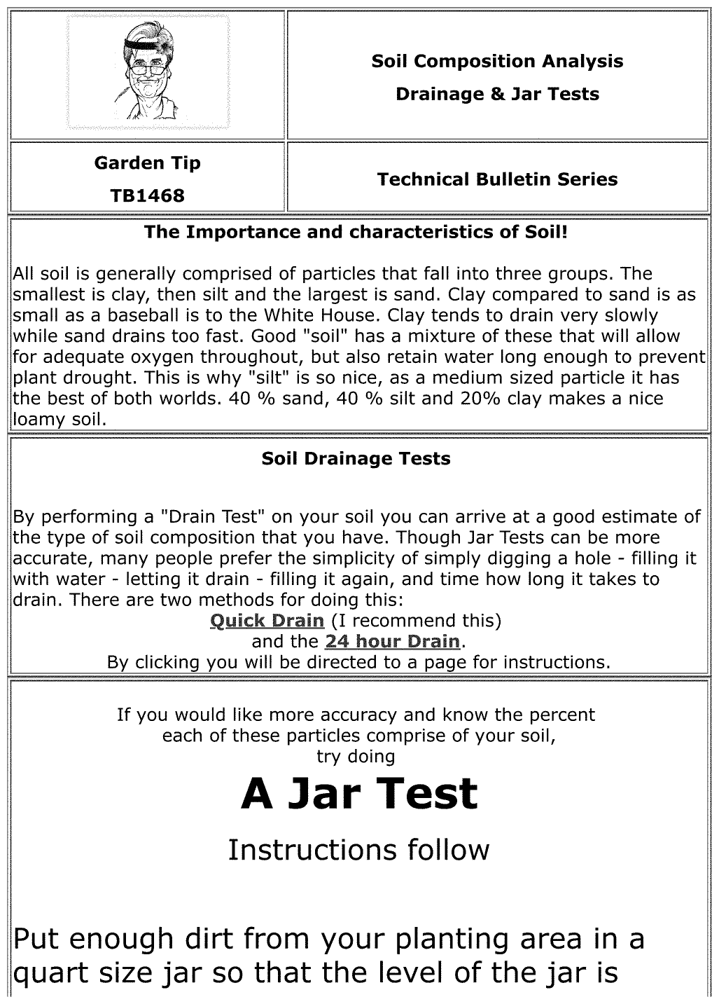

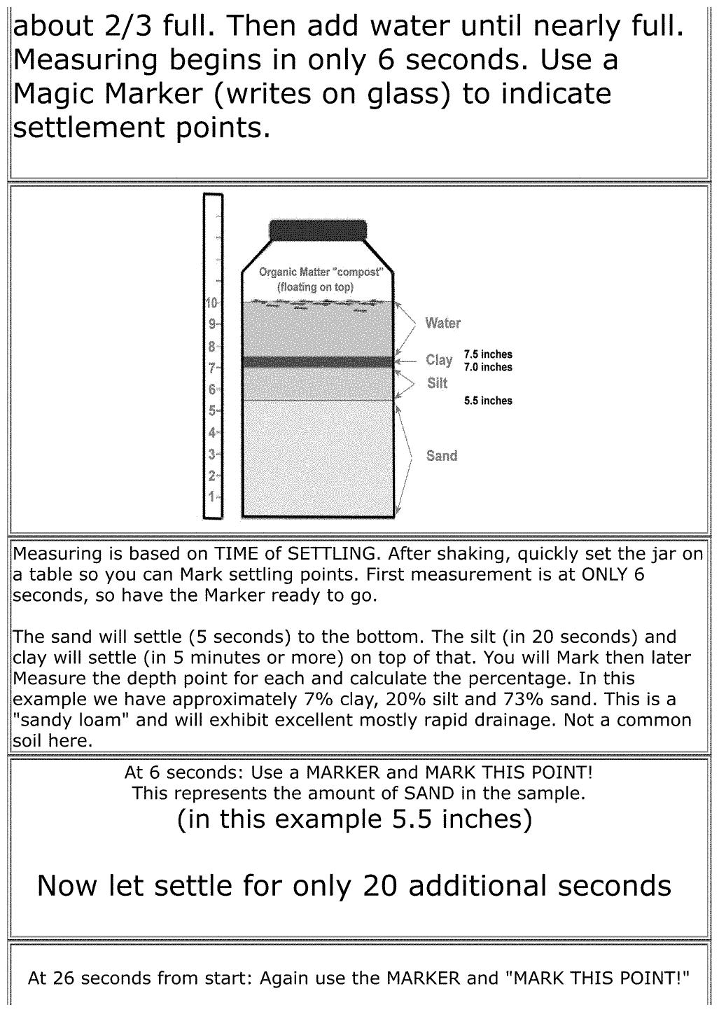

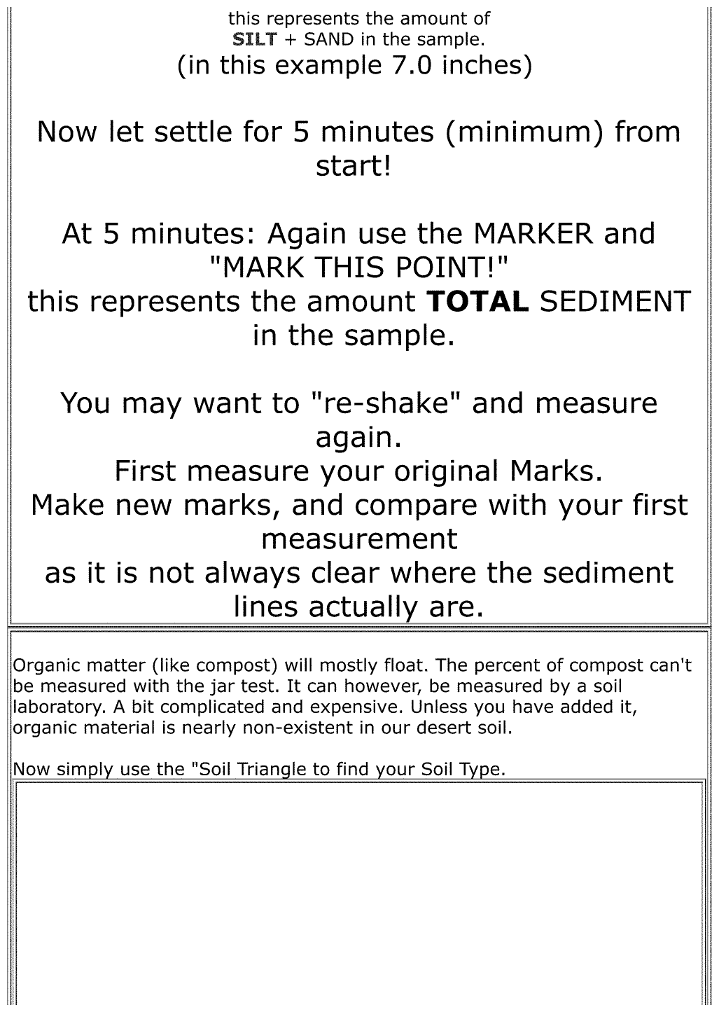

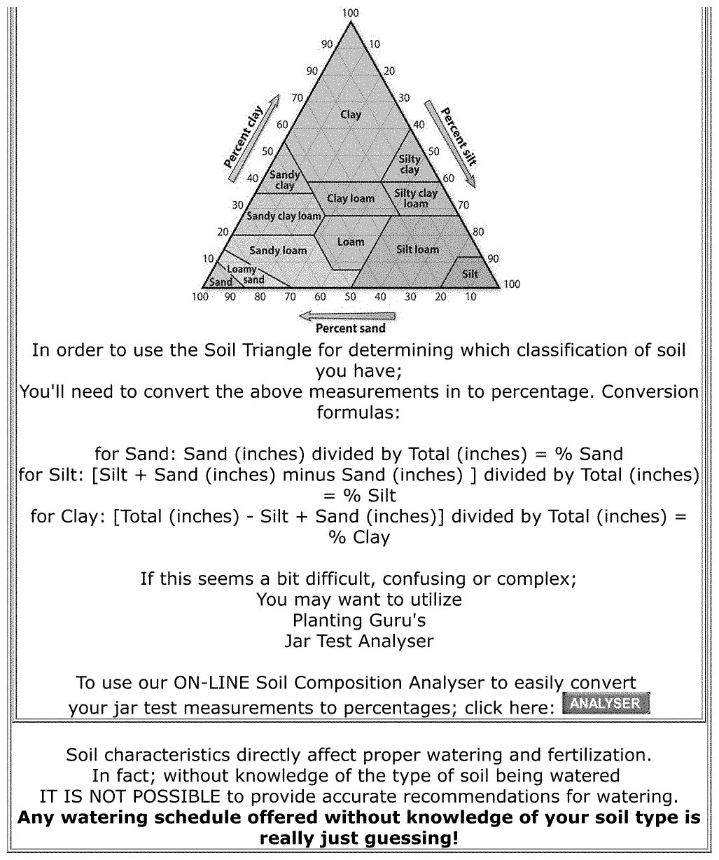

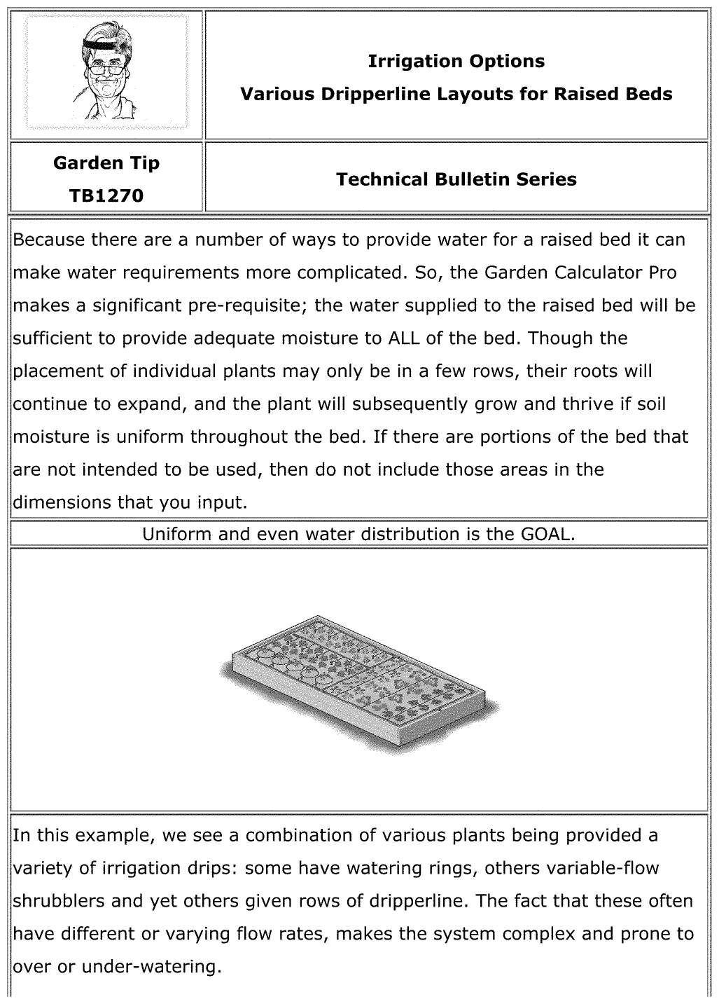

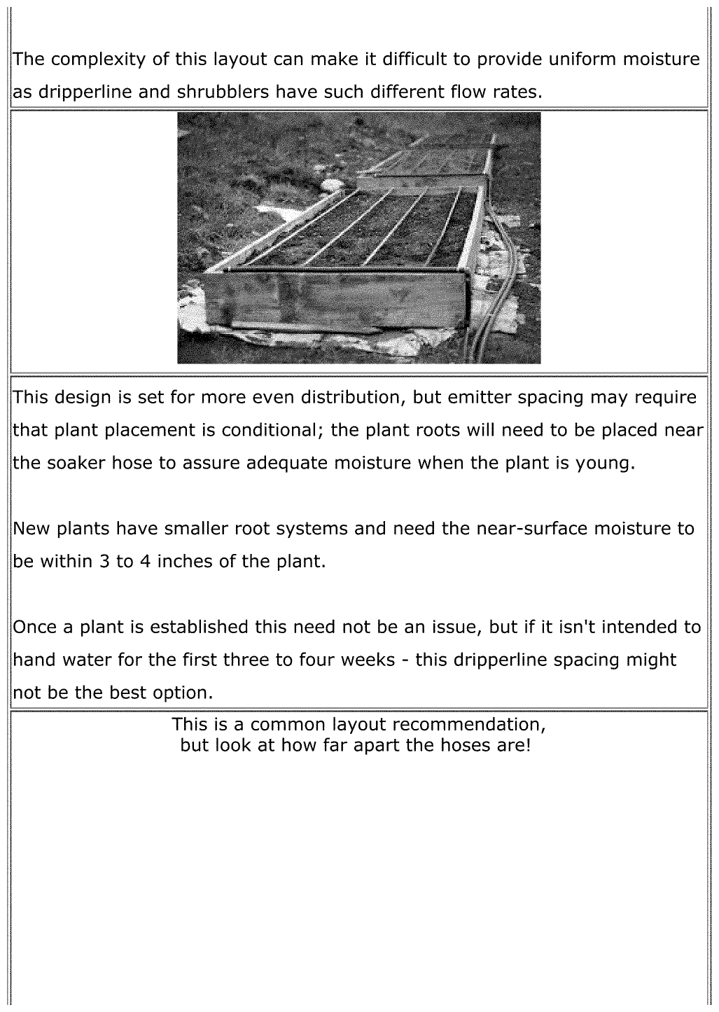

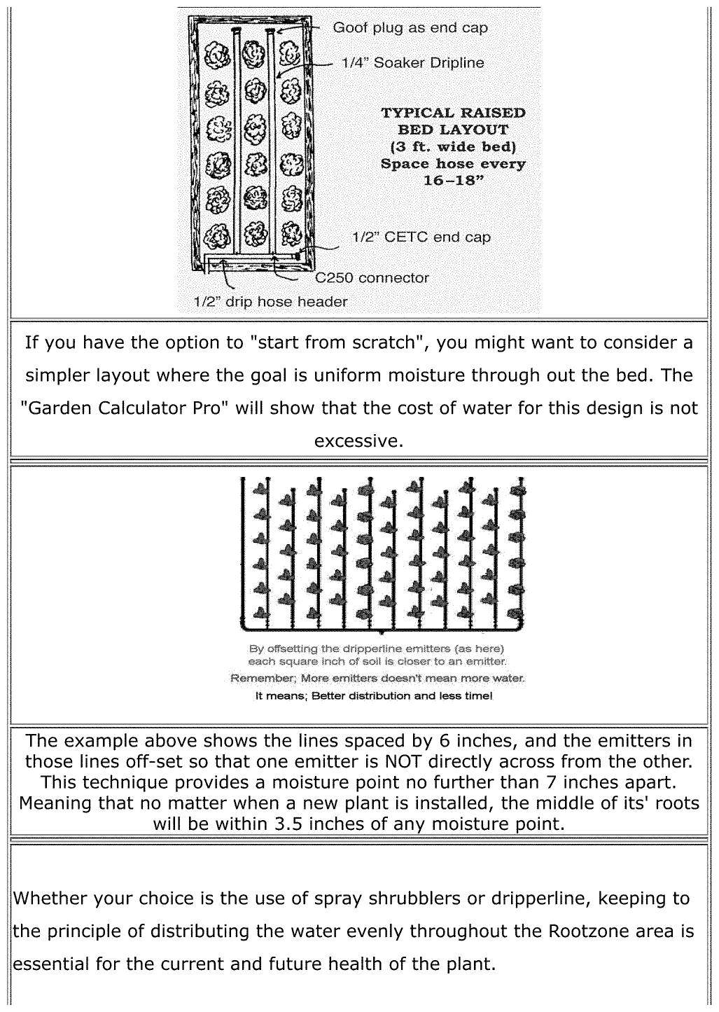

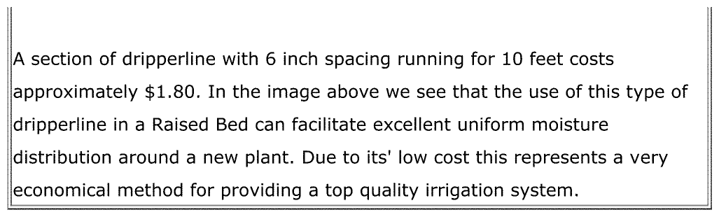

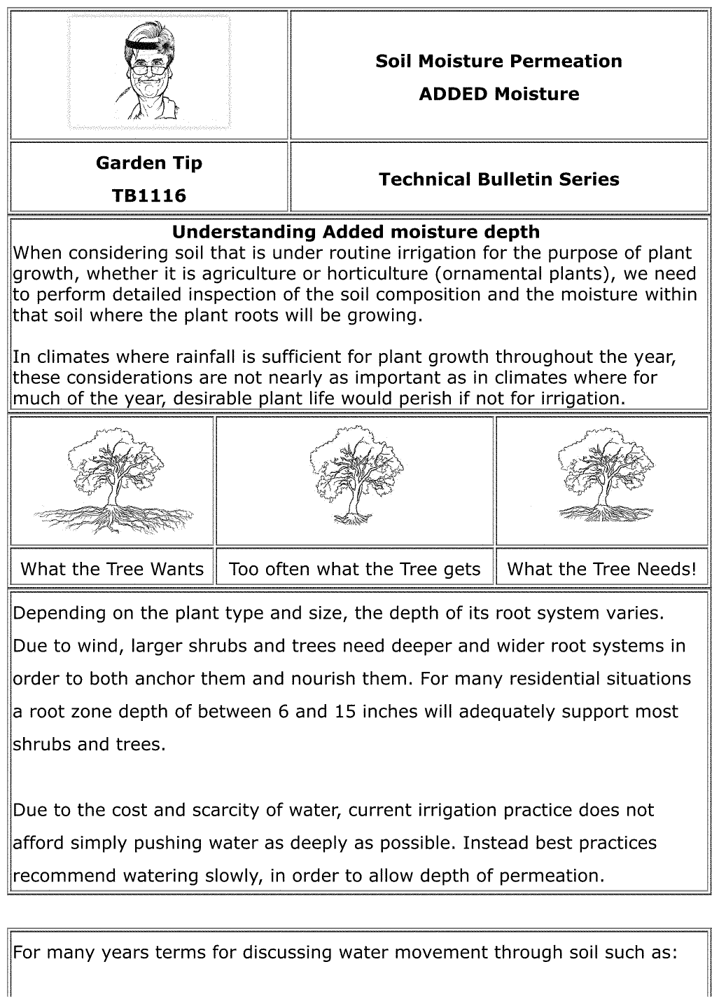

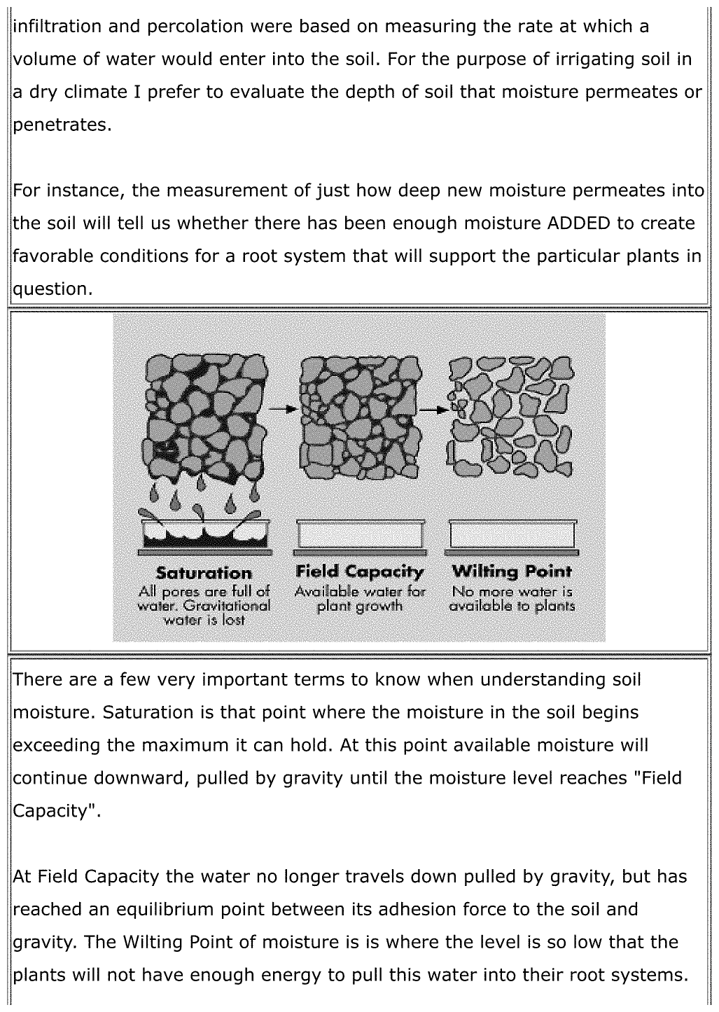

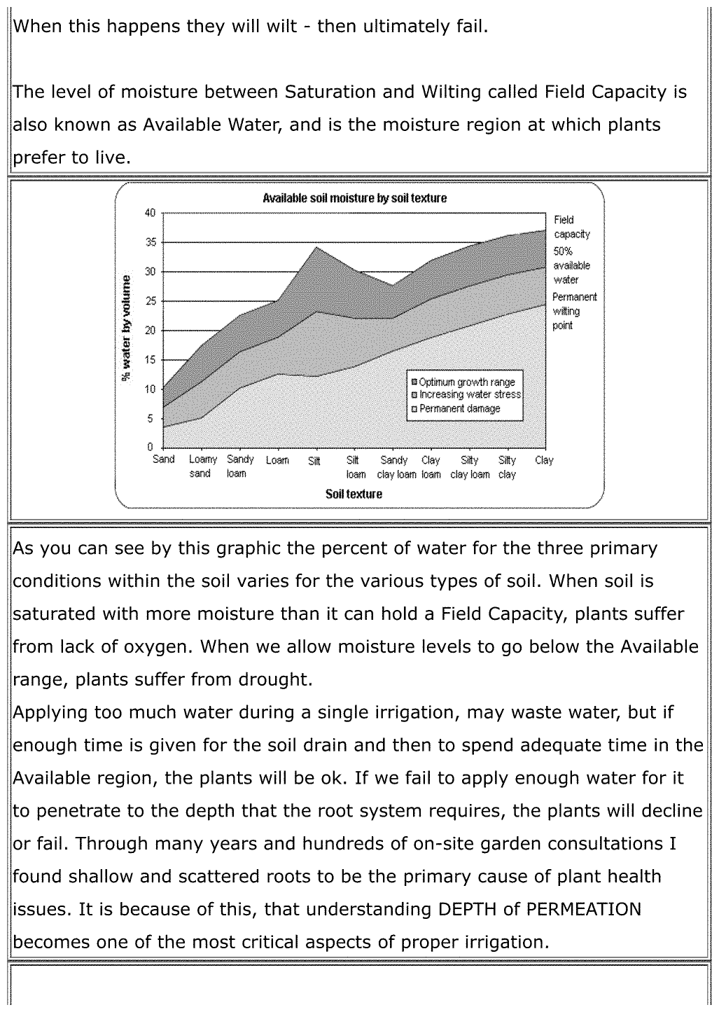

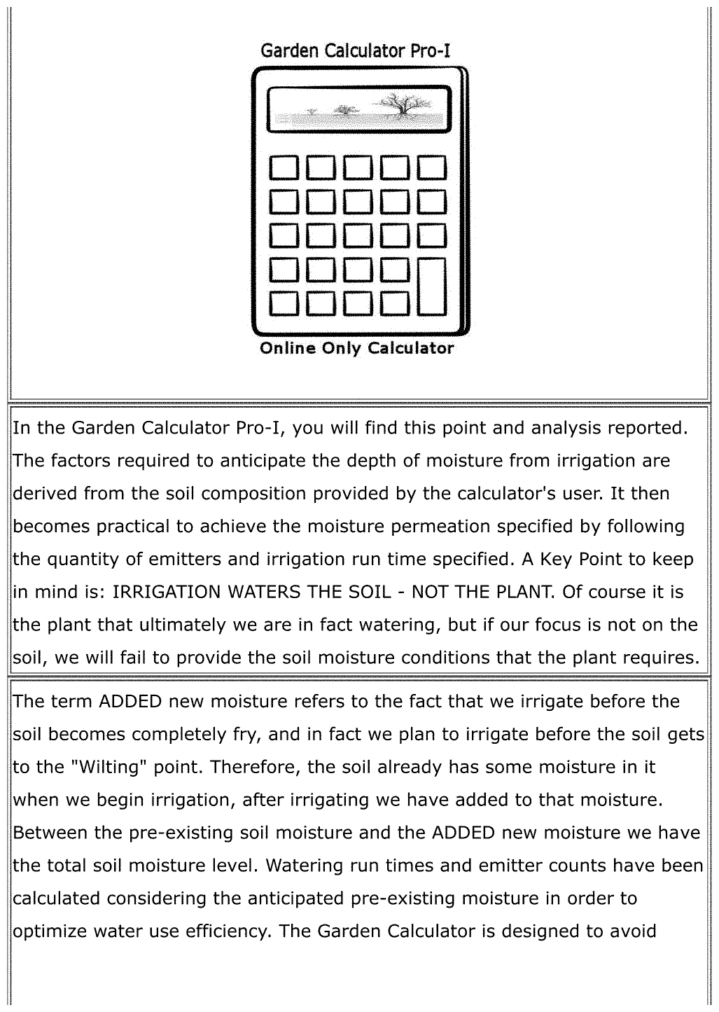

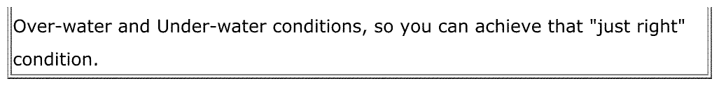

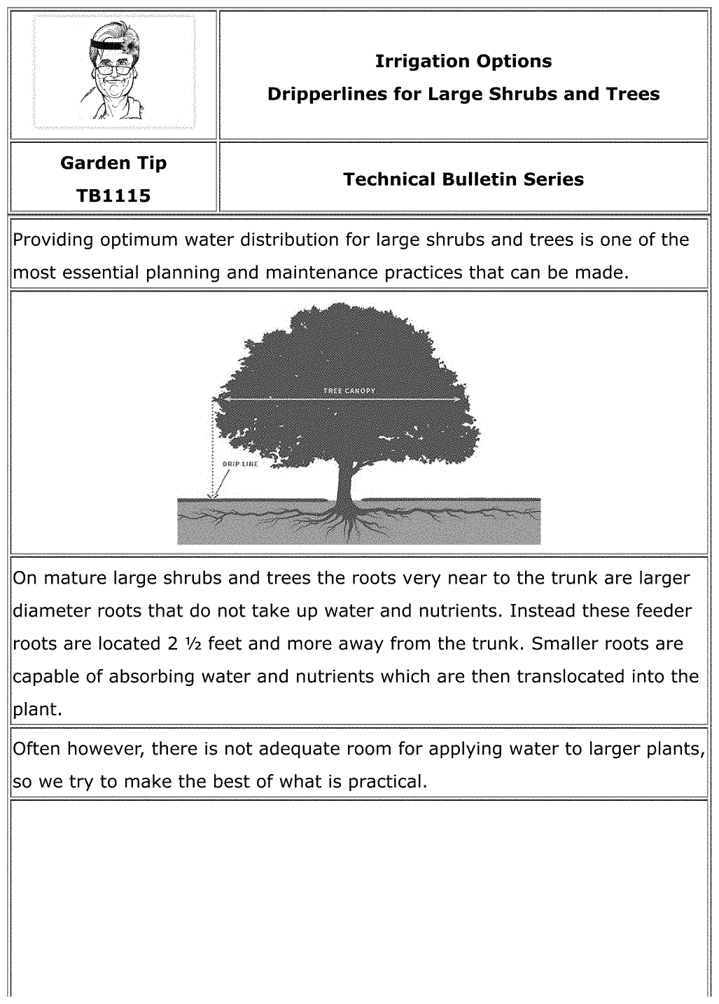

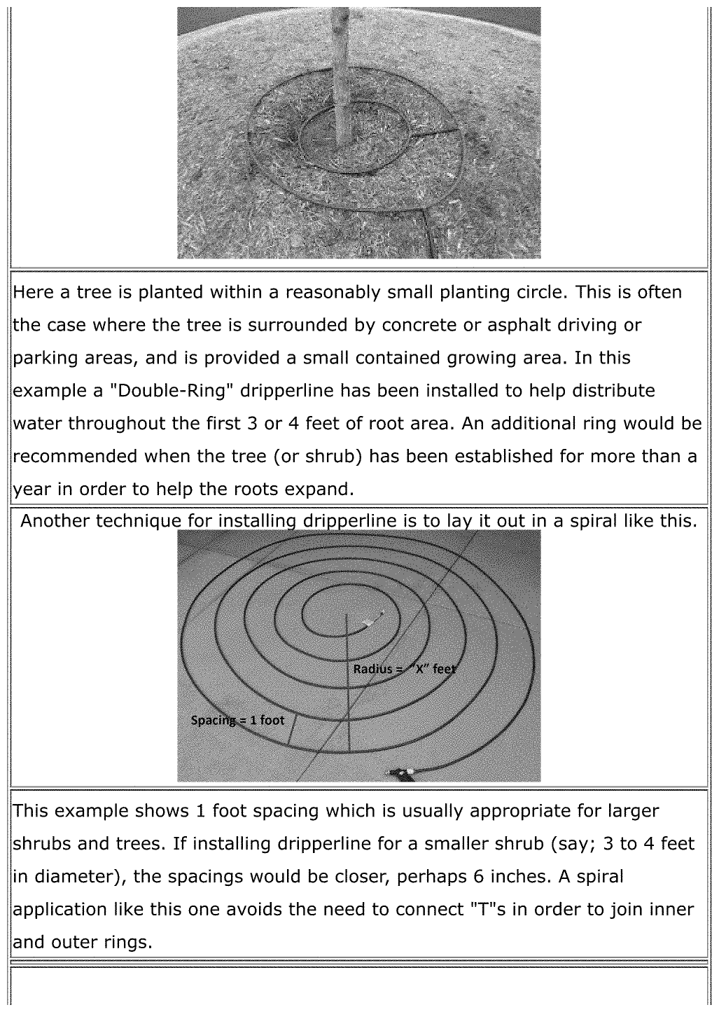

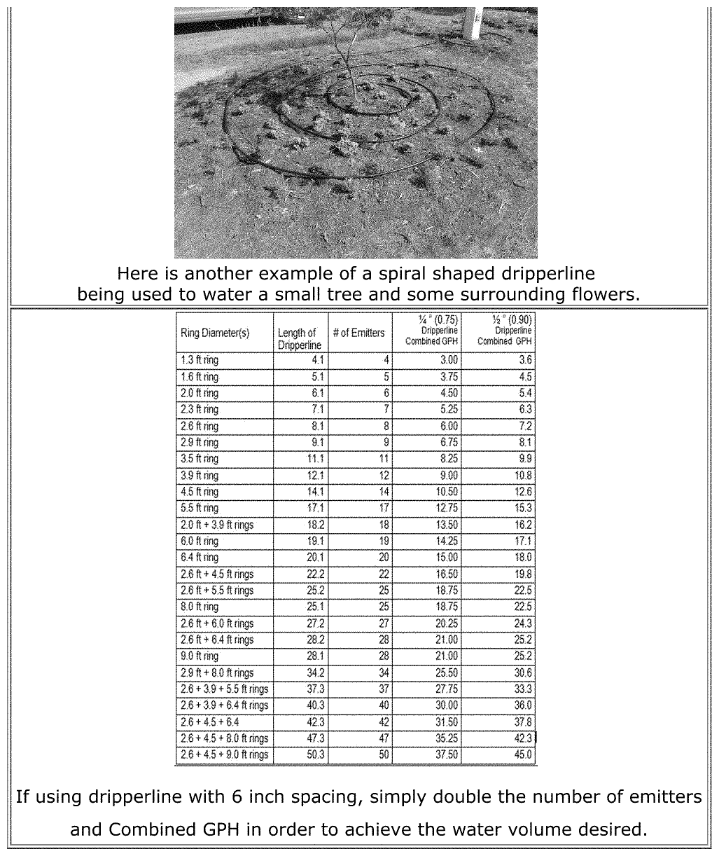

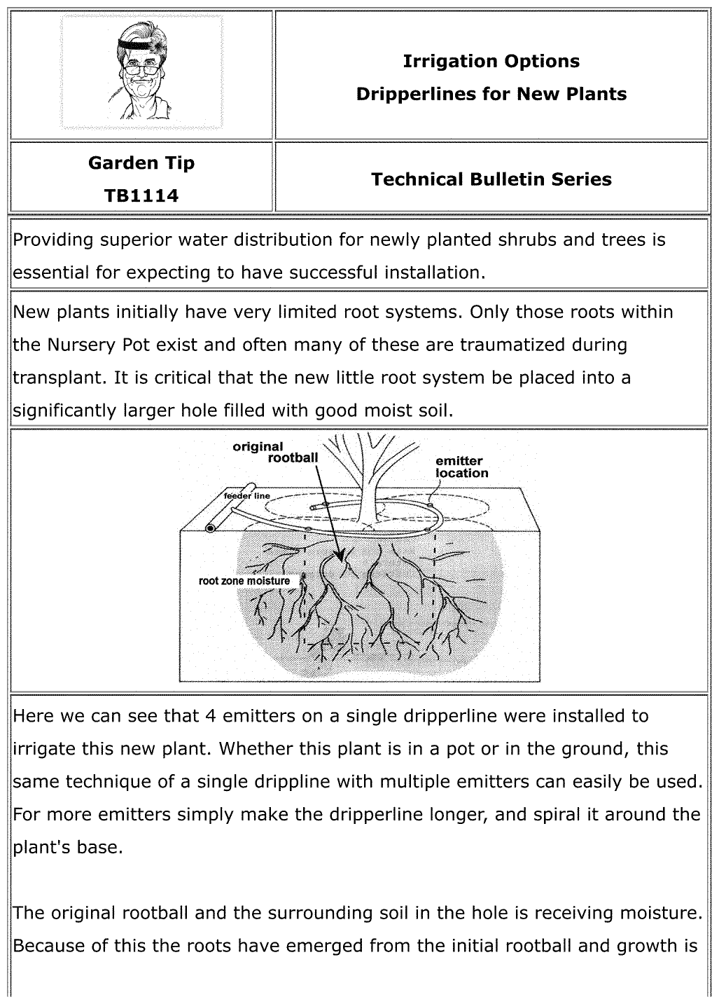

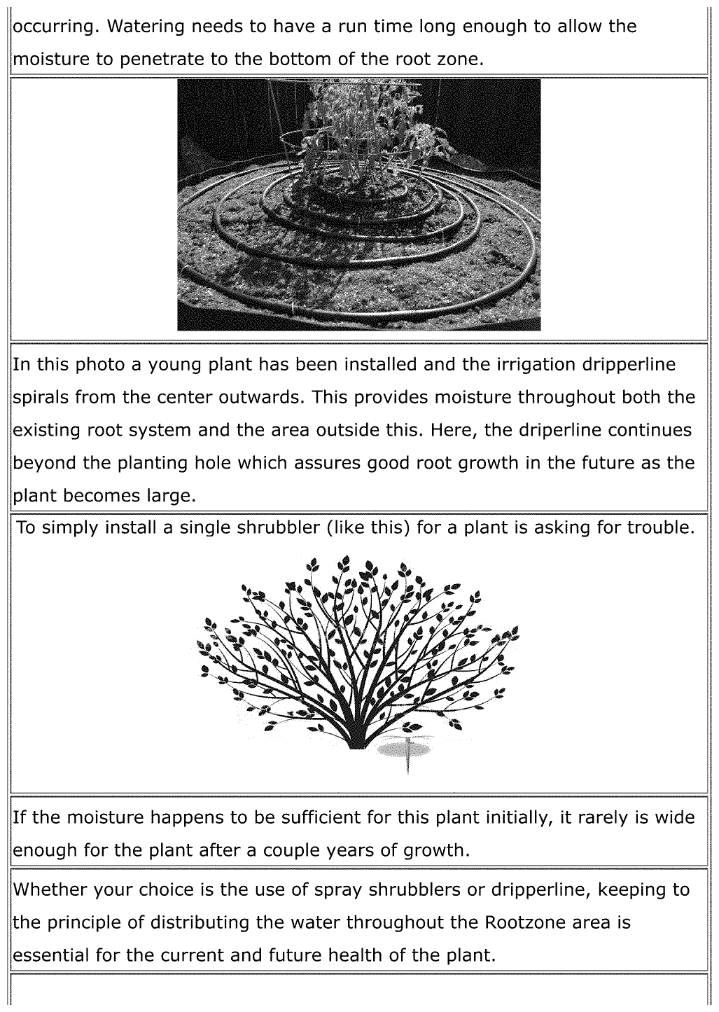

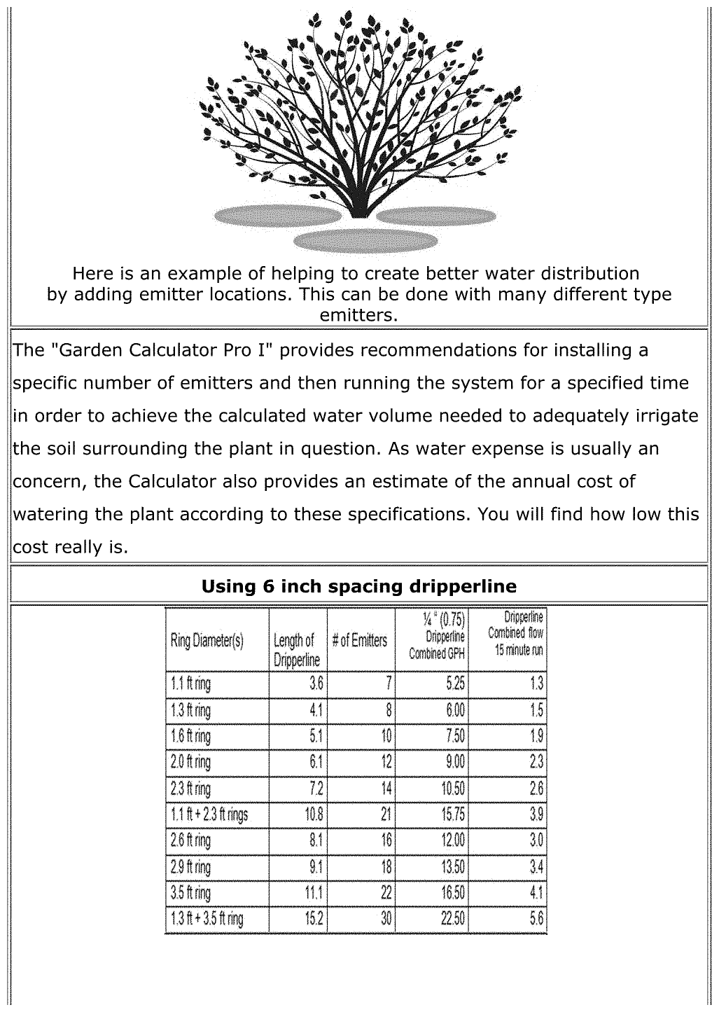

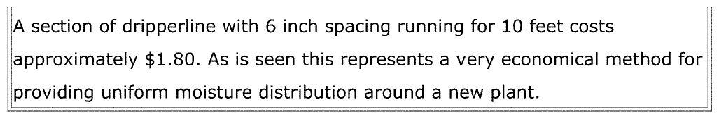

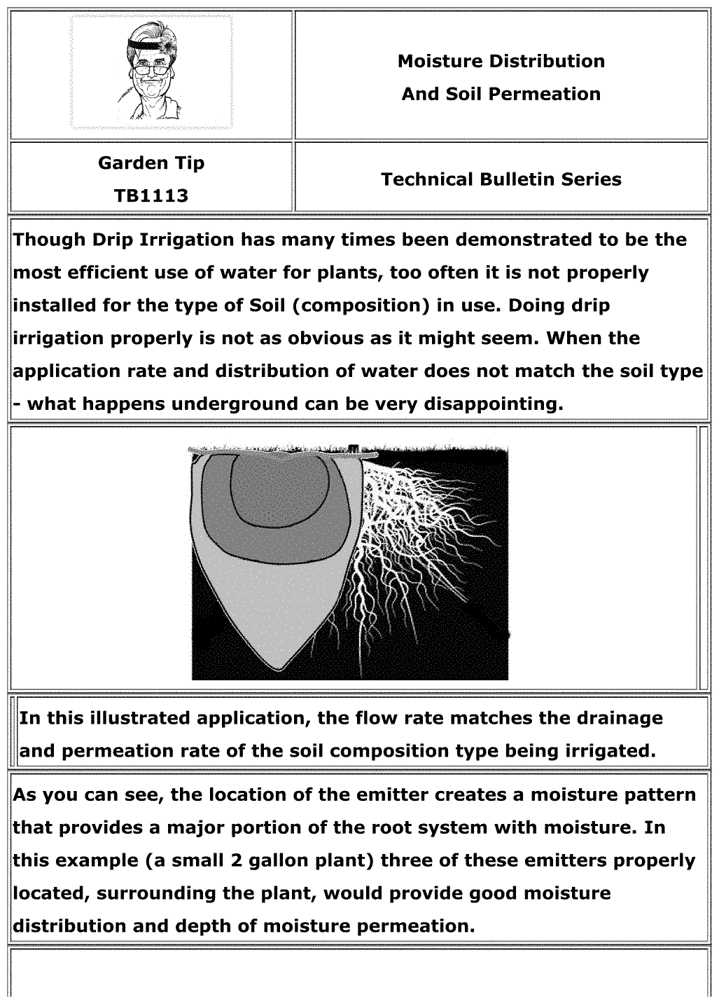

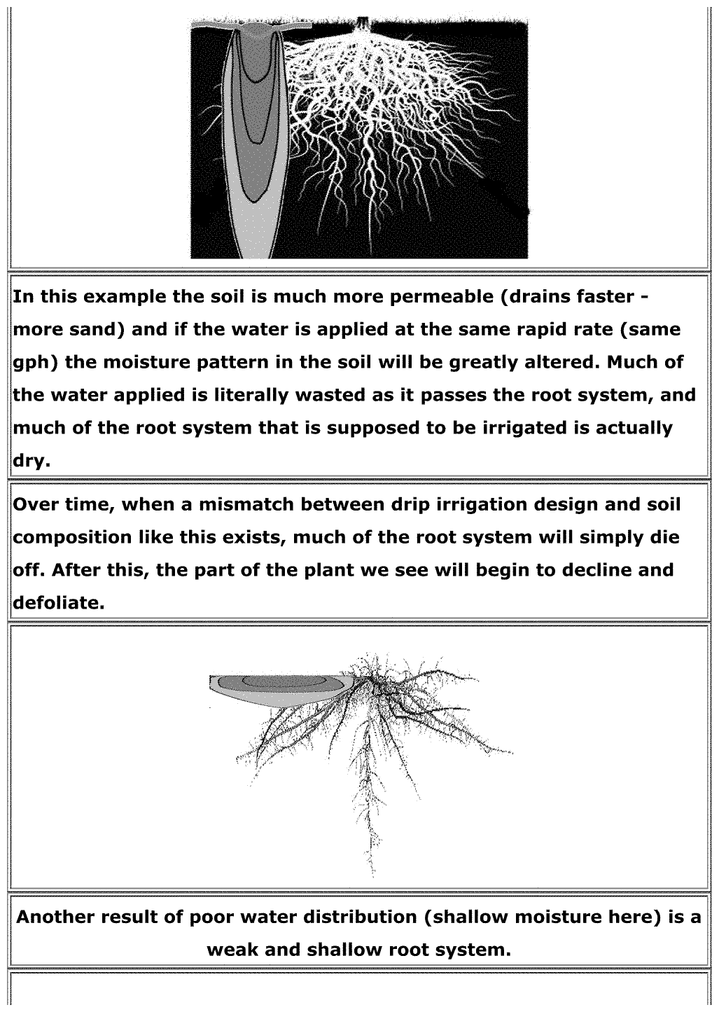

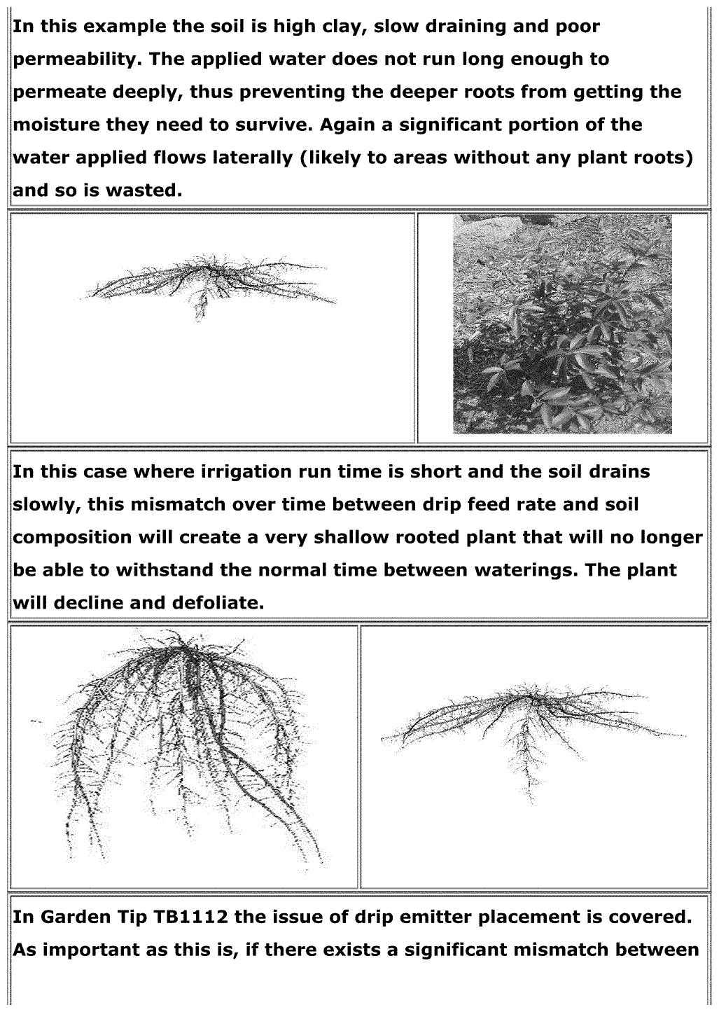

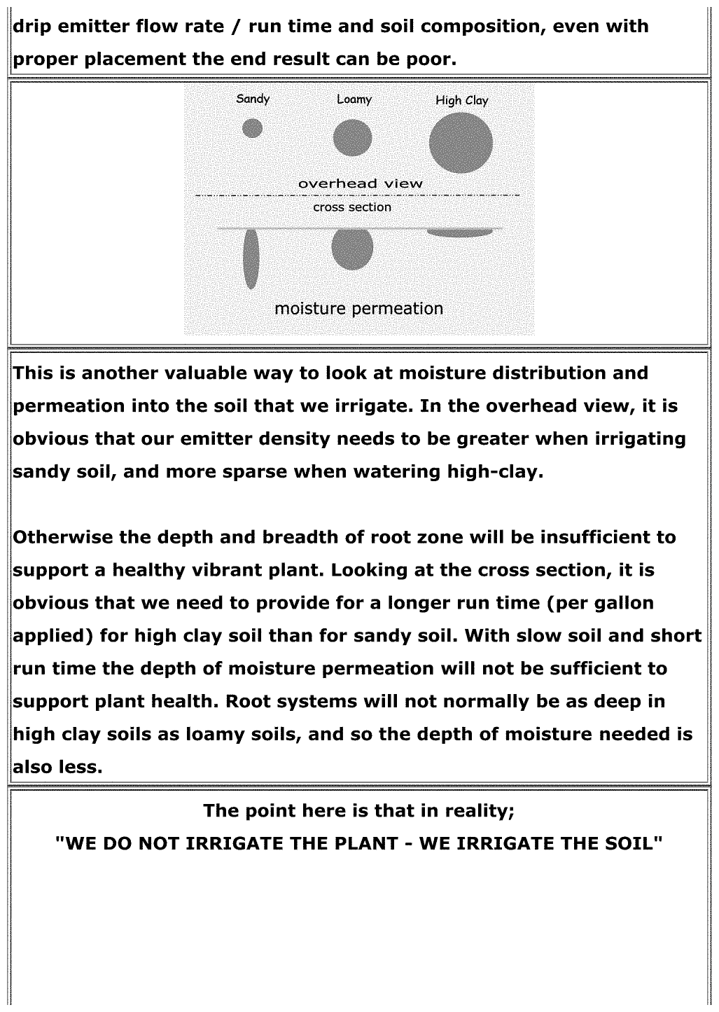

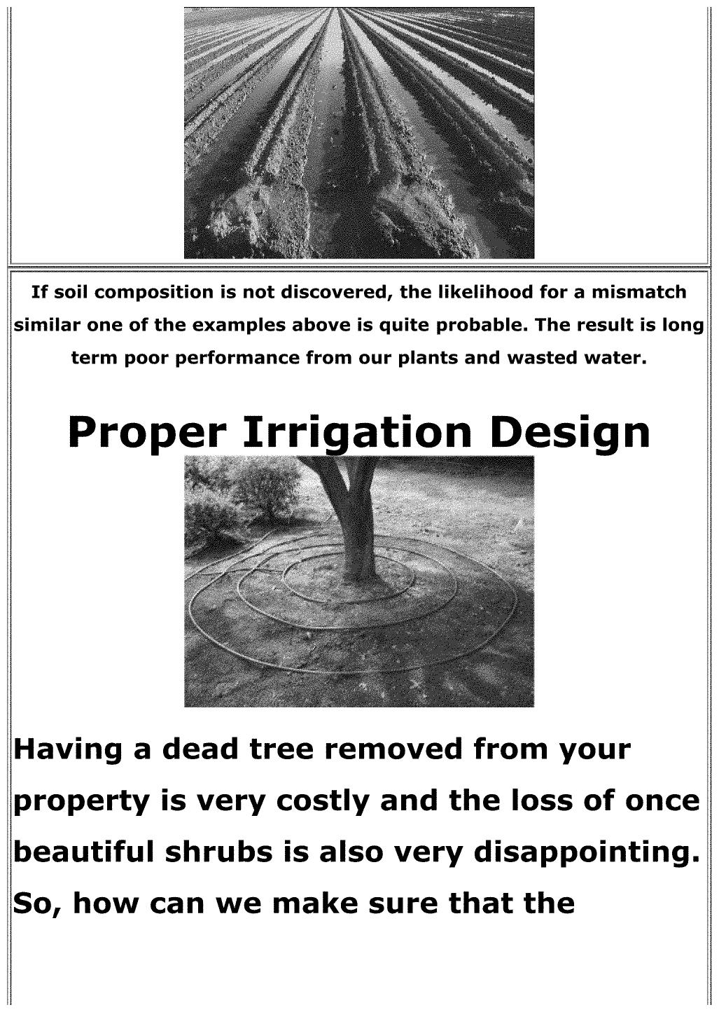

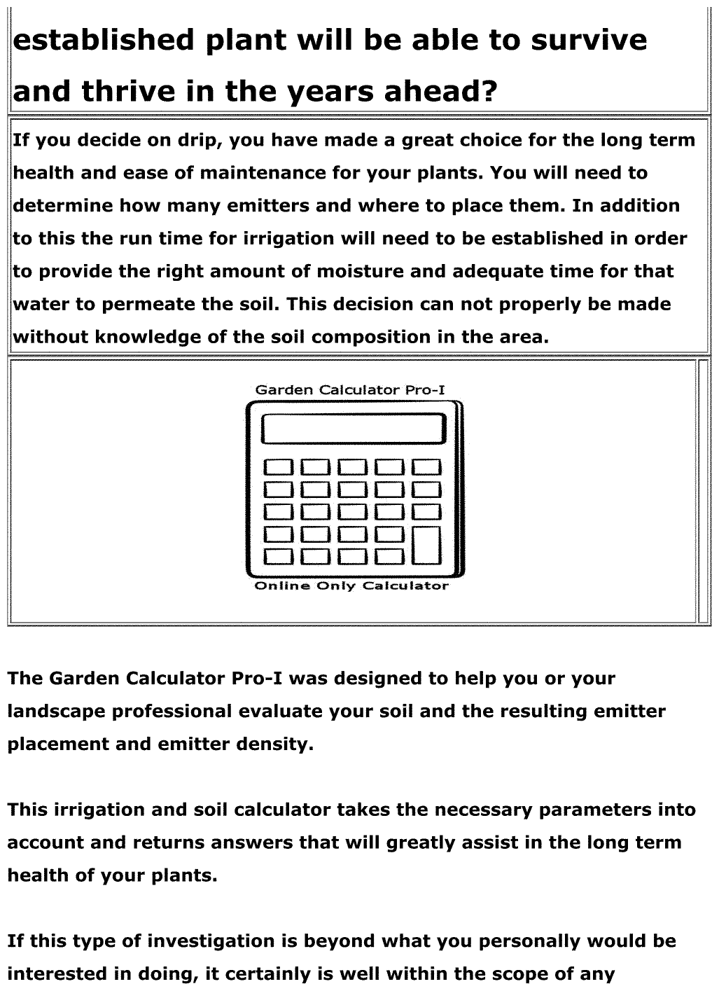

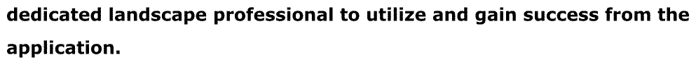

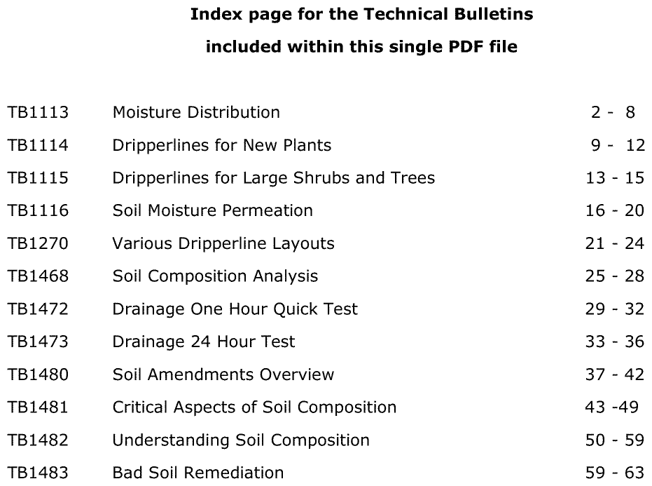

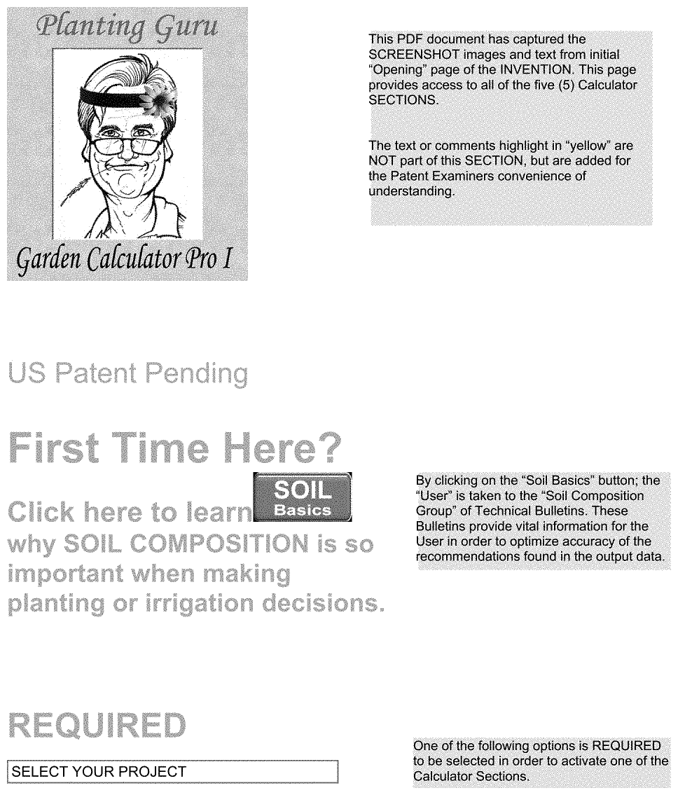

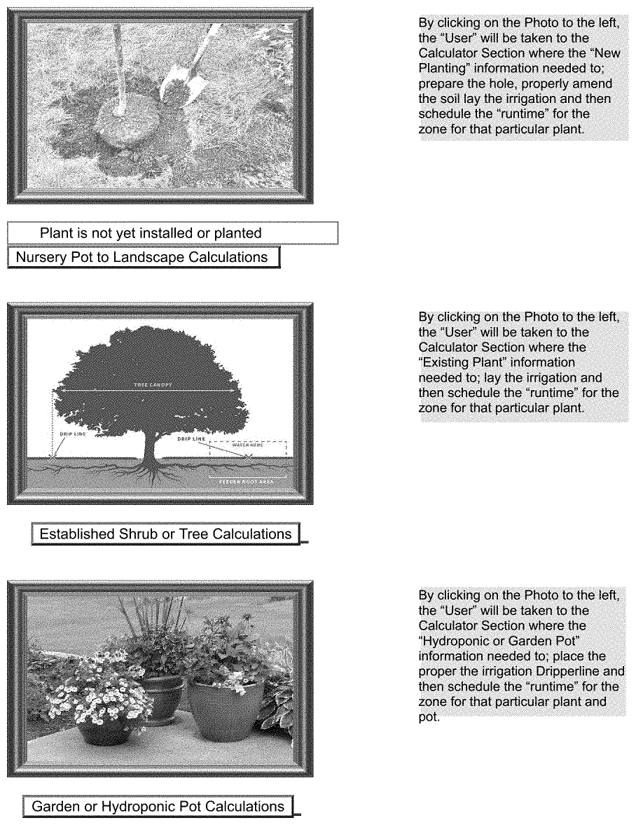

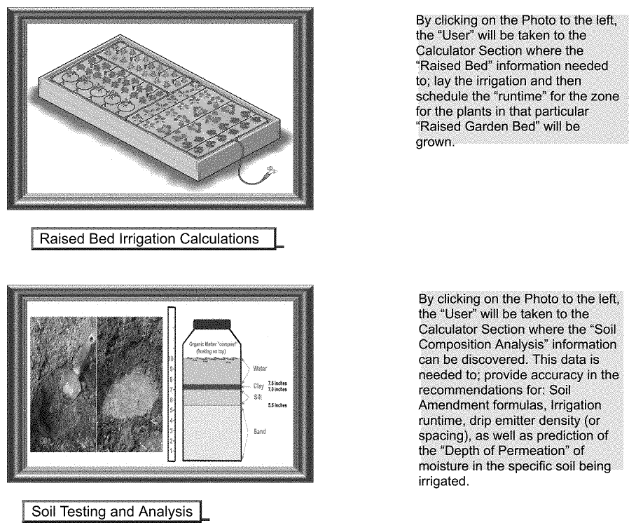

### NOMENCLATURE—TERMINOLOGY DEFINITIONS

[*01] “Native Soil” is considered that soil currently existing where the plant is located or is to be located. When considering a “Pot or Container” this term refers to the type of soil currently in that container.

[*02] “Soil Composition” is the characteristic particle make-up of: Sand, Silt and Clay within a particular soil. The mix of these particles sizes will determine the porousness of that soil and the rate at which water will infiltrate through it.

[*02a] “Soil Composition Type Statement” is term (ex; “Silty Clay Loam”) as found in the Standard Soil Triangle. This statement represents (within a few words) the category to which a particular soil belongs as regards Soil Composition. See Standard Soil Triangle.

[*03] “Jar Test’ is an experiment performed on a soil sample in order to determine its composition percentages of Sand, Silt and Clay. Explained thoroughly in Embodiment-TB1113-TB1483.pdf—section #TB1468; The results of this test form the basis of the increased accuracy of The INVENTION.

[*03a] “Standard Soil Triangle” is available throughout many horticultural pages on the Internet and utilizes the composition percentages of Sand, Silt and Clay as ascertained from the Jar Test in order to provide an appropriate “Soil Composition Statement” (such as: Silty Clay Loam, or Silt Loam, as seen below)

[*04] “Plant Size’ is a description that considers the dimensions of the “Canopy” (see image below) of a groundcover, shrub or tree.

[*05] “Plant Water Use Type” is a description relating to a particular plants typical ability to withstand drought, or infrequent watering. Ex: Heavy Water Use, Moderate Water Use, Drought Tolerant and Succulent. This classification can be “subjective” as to some degree each plant can adapt to the conditions in which it has been subject.

[*06] “Rootzone” is the soil volume (surface square foot multiplied by median depth) required for a particular plant and soil type in order to achieve plant health.

[*06a] “Root square foot area” is the surface area, located over the “Rootzone” where the irrigation system needs to provide moisture in order to maintain root growth and health.

[*07] “Optimum Soil Moisture” is the moisture level within the rootzone soil wherein there is an optimum balance between water and air. Too wet is bad as is too dry. (see image below)

[*08a] “emitter” or “drip emitter” is an opening in a dripperline or other irrigation flow control port where a regulated amount of water is released.

[*08] “emitter density” is the number of irrigation drip emitters per surface square foot of soil.

[*09] “Runtime” is the time period (measured in minutes) that a particular Irrigation System Zone (or valve) is activated and providing water.

[*10] “Irrigation System Zone” within a drip irrigation system there are often multiple valves that are operated on separate Controller Zones. Therefore, the Zone are those drip outlets connected to that specific valve.

[*11] “Moisture Permeation Depth” is the depth of soil that applied water moisture will penetrate during an irrigation event.

[*11a] The Moisture Permeation Rate is how fast this moisture will move downward through the soil. One would extract a sample of the soil beyond the depth to which it is estimated moisture has traveled, and examine that sample.

[*11b] “Infiltration Rate” is the rate at which a quantity of water will drain from a hole in the soil. One measures the drop in water level over time.

[*12] “Optimum Moisture Distribution” is the surface distribution uniformity for Optimum soil Moisture levels. Optimal plant and root growth occurs when uniformity of moisture is high and roots are encouraged to grow and thrive.

[*12a] “Moist Soil Region” is that area and depth of soil surrounding a plant that carries sufficient moisture to sustain the plant. See FIG. 3.

[*13] “Puddling and Run-off” this occurs when water is applied at a rate too fast for the particular soil composition type to absorb. The result is often that this water moves to a location that was not intended for moisture.

[*14] “Pre-Set Runtime” is a runtime that already has been established for the particular zone that a new plant is intended to be added into. As this critically affects how the Calculators should determine recommendations, this information must be entered into the data inputs from the User. Importantly; the Calculators can properly deal with this issue, which is a major benefit to the INVENTION.

[*15] “drainage rate” is rate (in minutes) that a hole filled with water will drain. This is also a relative indication of what moisture permeation rate will be. Either of the two can be used to approximate “Soil Composition [*01].

[*16] “Dripperline” is a length of polymer tubing which has flow rate control emitters fabricated right into the tubing. This line generally has a diameter of ¼th inch or ½ inch. The distance between emitters will typically vary from 6 inches to 12 or 18 inches.

[*17] “GCP” is the acronym for “Garden Calculator Pro-I”, or the INVENTION used in various places throughout this application.

[*18] “Users” (of this Device, the INVENTION) is meant to include: Landscape Professional Installation or Maintenance personnel, Professional Nursery Associates (often giving advice as requested by patrons of their place of business) and Gardeners (performing planting or irrigation functions for their own landscape or garden).

[*19] “Educational Bulletin” is a document provided (as a linked webpage) in the (GCP) in order to facilitate a better understanding by the User and improve accuracy of the recommendations given.

[*20] “Grow Media” is a material that can be used to help support plant root system life. This material will in most cases provide air space and consist of things such as: various soil particles sizes (sand, silt) organic mulch (of various sizes), perlite, clay pellets, etc.)

[*20b] “Soil Amendments” are various types of “Grow Media” that would be mixed together with Native soil in order to modify its porosity, permeation and infiltration rate.

[*20c] “Amended” is the act and or the result of mixing together various size soil particles or other grow media particles with the intention of moderating the porosity and drainage rate of that soil.

[*21] “Irrigation Controller” is the device that activates the valve that controls water flow to a particular plant within a landscape or garden. This device will likely control many such valves.

[*21b] “Irrigation Event” is a single Runtime cycle of water being applied to a particular plant.

[*22] “Pot or Container” size is specified in Dry Measure, and indicates the initial root system size for a new plant. When purchased at a retail nursery this would be anything from a “1 gallon” plant to a “20 gallon” (or more) plant for example.

[*23] “Desert Climates” are geographical areas where normal rainfall is less than 14 inches per year, or where it is common for there to be unmeasurable rainfall for periods longer than 2 months. Thus, requiring some form of irrigation to keep plants alive during this time.

[*24] “dry areas within the rootzone” are those places located within a particular plant's Rootzone where moisture after an irrigation event does not exist. This is typically caused by poor irrigation distribution.

### PRIOR ART AND DISCUSSIONS

| | | |
|---|---|---|
| Patent | 10,902,483 | Computer-implemented method and |
| # 1 | | computer program for designing and |
| | | cost-estimating irrigation systems |
| Patent | 8,738,189 | Irrigation controller water management |
| # 2 | | with temperature budgeting |
| Patent | 5,176,163 | Flow-controlled irrigation system |
| # 3 | | |
| Patent | 5,696,671 | Evapotranspiration forecasting |
| # 4 | | irrigation control system |
| Patent | 6,823,239 | Internet-enabled central |
| # 5 | | Irrigation Control |
| Patent | 10,874,061 | Drip irrigation system |
| # 6 | | |
| Patent | 3,762,170 | IRRIGATION APPARATUS |
| # 7 | | AND METHODS |
| Patent | 8,494,682 | Method of and system for improving |
| # 8 | | sprinkler system efficiency |
| Patent | 10,856,477 | Plant watering system and method |
| # 9 | | |
| Patent | 10,785,927 | Irrigation system |
| # 10 | | |
| Patent | 10,440,903 | Drip line emitter and methods |
| # 11 | | relating to same |

As to be understood throughout this patent application—its' Abstract, Claims, Background, and Description; This INVENTION is a device provided to assist in the education process for persons working in the landscape, garden and nursery supplies industry.

The “GCP” is not an actual controlling device, or irrigation part. In searching for “Prior Art” I was not successful in finding educational facilitating devices, but only actual controlling devices or system parts. I present herein above other inventions of this type that seemed closest in application to the “GCP”.

The claims made by the above listed patents have been examined to see if there is any claim that relates to those CLAIMS made in this Application. Through the examination of any of the aforementioned patented devices, their description and their claims; It is apparent to the Claimant of this Application, that the Device of this Application and its Claims are substantially different than those of the aforementioned and referenced devices.

C-1) The Procedure consisting essentially of a combination of algorithms for a computer program to gather data related to existing “Soil Composition” from a particular “User” [*18] located in the field (at the site of a Plant or planting); and subsequently analyze this data and return educational results that provide accurate, comprehensive and critical planting and irrigation system design and scheduling recommendations.

C-1. a) The Procedure consisting essentially of Browser instructional language (such as HTML), as relates to Claim (C-1) for a computer program to visually construct the pages in such a way as to present information requests and resulting recommendations in a manner expressly convenient to its use on the Internet and with a cellular telephone device, and for the subsequent transmittal of this information to others through this same device.

C-2) The Procedure consisting essentially of a combination of algorithms for a computer program to gather “Soil Composition” data (C-1), from a “User's” performance of a “Jar Test” [*03]; then to mathematically analyze this data and to convert measurements into percentages for cross-reference use on the “Soil Triangle” in order to determine the resulting “Soil Composition Statement” [*02a].

C-2. a) The procedure consisting essentially of a combination of algorithms for a computer program to convert “Jar Test” measurements directly into a “Soil Composition Type” statement without having to utilize the cumbersome cross-reference process required of the “Soil Triangle”. Measurement data input will calculate and produce the same Soil Type statement as found with the Soil Triangle.

C-3) The Procedure consisting essentially of a combination of algorithms for a computer program to gather data, from a particular User [*1.8] related to a specific Plant size [*04], “Plant Water Use Type” [*05], and “Soil Composition Statement” [*02a]; to analyze this data in order to determine and specify an appropriate cubic volume of soil which would be required to be Irrigated in order to provide an adequately sized root system.

C-3. a) The Procedure consisting essentially of a combination of algorithms for a computer program (as specified in claim C-3) to calculate the appropriate “Rootzone” [*06] square foot surface area, it's depth and its resultant soil volume to be irrigated for a particular new or existing plant.

C-3. b) The Procedure consisting essentially of a combination of algorithms for a computer program (as specified in claim C-3. a) to calculate and recommend the correct volume of water (in gallons) required to provide “Optimum Soil Moisture” [*07] throughout a particular plant's required Rootzone volume as specified by (C-3) above.

C-3. c) The Procedure (as relates to C-3. a) consisting essentially of a combination of algorithms for a computer program to calculate the optimum number of drip emitters [*08a], their flow rate, the “Emitter Density” [*08] and subsequent square foot area coverage, and provide this recommendation for a particular New or Existing Plant.

C-3. d) The Procedure (as relates to C-3. C) consisting essentially of a combination of algorithms for a computer program to analyze and then specify the optimum distance between drip emitters.

C-3. e) The Procedure consisting essentially of a combination of algorithms for a computer, as relates to (C-3. C), (C-1. A) and “Emitter Density” [*08] to analyze and recommend an appropriate “Dripperline” [*16] layout within a specified area that will provide the optimum number of Emitters and appropriate Emitter Density.

C-3. e) The Procedure consisting essentially of a combination of algorithms, as relates to (C-3. c) for a computer to calculate and specify the proper “Irrigation Controller” [*21] single event “Runtime” [*09] on an “Irrigation System Zone” [10]. This Runtime would be that needed to obtain the optimum volume of water as specified in (C-3. b) above.

C-3. f) The Procedure consisting essentially of a combination of algorithms for a computer to accurately recalculate a modified “Emitter Count” and “Emitter Density” when a User's “Pre-Set Runtime” [* 14] is significantly different from (C-3. e) as regards the irrigation zone a specific plant is to be serviced by; while still providing optimum rootzone moisture levels.
Note: In cases where a plant is being added into an existing irrigation zone, there may not exist an option to set the runtime differently than it is already set. Therefore, calculations must be done to compensate for this while still avoiding: puddling, run-off or incorrect water volume.

C.4) The Procedure consisting essentially of a combination of algorithms, as relates to Claim (C.3) for a computer program to gather data, from a particular User [*18] related to a specific pot or container size [*22] for a Plant; to analyze this data in order to determine and specify an appropriate cubic volume of soil which would be required to be “Amended” [*20c] as well as provide a recommendation for what grow media to use for amending that soil surrounding the new plant.

C-4. a) The Procedure consisting essentially of a combination of algorithms, as relates to (C-4) for a computer to gather data from a particular “User” the results from (C-2), (C-3) as well as (C-4) and then to calculate (and subsequently recommend) the amount and the various types of different “Soil Amendments' [*20b] needed to adjust a specified soil's porosity and permeability in order to obtain improved soil composition and New Plant root health and improved moisture permeation. The intent of this is to create soil capable of sustaining plant root growth and health.

C-4. b) The procedure consisting essentially of a combination of algorithms, as relates to (C-1) and (C-4 a) for a computer to calculate the revised “Soil Composition” for an original Native Soil once it has been amended/modified by the suggested Amendment Formula.

C-5) The Procedure consisting essentially of a combination of algorithms for a computer to calculate from the data provided by (C-1), (C-3), (C-3. a) and (C-3. b) the depth to which optimum moisture will permeate following an Irrigation Event” [*21b].

C-5. a) The Procedure consisting essentially of a combination of algorithms for a computer, and as relates to (C-5) to analyze and compare the different “Moisture Depths” that would be obtained with Original Native Soil type with that of the New Amended Soil Type.

C-6) The Procedure consisting essentially of a combination of algorithms, as relates to (C-1) and (C-4. b) for a computer to calculate the fastest optimum rate of applied irrigation before water “Puddling and Run-off” [*1.3] are likely to occur.
